(19) United States
(12) Patent Application Publication
(10) Pub. No.: US 2023/0095606 A1
(43) Pub. Date: Mar. 30, 2023

(54) METHOD FOR TRAINING CLASSIFIER, AND DATA PROCESSING METHOD, SYSTEM, AND DEVICE

(71) Applicant: Huawei Technologies Co., Ltd., Shenzhen (CN)

(72) Inventors: Chanfei SU, Shenzhen (CN); Yong Wen, Dongguan (CN); Kalander Marcus, Hong Kong (CN); Lujia Pan, Shenzhen (CN)

(21) Appl. No.: 18/070,682

(22) Filed: Nov. 29, 2022

Related U.S. Application Data
(63) Continuation of application No. PCT/CN2021/093596, filed on May 13, 2021.

(30) Foreign Application Priority Data
May 30, 2020 (CN) 202010480915.2

(51) Int. Cl. G06N 3/04; G06V 10/774

(52) U.S. Cl. CPC G06N 3/04; G06V 10/774

(57) ABSTRACT

A data processing method and apparatus are disclosed. The method includes: obtaining a sample dataset, where each sample in the sample dataset includes a first label; dividing the sample dataset into K sample sub-datasets, determining a group of data from the K sample sub-datasets as a test dataset, and using sample sub-datasets other than the test dataset as a train dataset; training the classifier by using the train dataset, and classifying the test dataset by using a trained classifier, to obtain a second label of each sample in the test dataset; obtaining a first indicator and a first hyper-parameter at least based on the first label and the second label; obtaining a loss function of the classifier at least based on the first hyper-parameter, where the loss function is used to update the classifier; and completing training of the classifier when the first indicator meets a preset condition.

### CROSS-REFERENCE TO RELATED APPLICATIONS

This application is a continuation of International Application No. PCT/CN2021/093596, filed on May 13, 2021, which claims priority to Chinese Patent Application No. 202010480915.2, filed on May 30, 2020. The disclosures of the aforementioned applications are hereby incorporated by reference in their entireties.

### TECHNICAL FIELD

The present disclosure relates to the field of artificial intelligence, and specifically, relates to a method for training a classifier, and a data processing method, system, and device.

### BACKGROUND

With rapid development of deep learning, big datasets also become increasingly common. For supervised learning, quality of a label corresponding to train data plays a vital role in a learning effect. If label data used in learning is incorrect, it is difficult to obtain an effective prediction model. However, in actual application, many datasets contain noise, that is, labels of data are incorrect. There are many reasons for noise in datasets, including: Manual annotation is incorrect, there is an error in a data collection process, or it is difficult to ensure label quality by obtaining a label through online inquiry of a customer.

A common practice of processing a noisy label is to constantly check a dataset to identify a sample with an incorrect label, and correct the label of the sample. However, this solution usually requires a lot of manpower to correct labels. Some other solutions are to design a noise robust loss function or use a noise detection algorithm to filter out noisy samples and delete the noisy samples. In some of the methods, noise distribution is assumed and the methods are applicable only to some particular noise distribution cases. As a result, it is difficult to ensure a classification effect. Alternatively, a clean dataset is required for assistance. However, in actual application, it is usually difficult to obtain a piece of clean data. Implementation of this solution has a bottleneck.

### SUMMARY

Embodiments of the present disclosure provide a method for training a classifier. A classifier with a good classification effect can be obtained without requiring an additional clean dataset and additional manual annotation.

To achieve the foregoing objective, the present disclosure provides the following technical solutions:

A first aspect of the present disclosure provides an example method for training a classifier. The method may include: obtaining a sample dataset, where the sample dataset may include a plurality of samples, each of the plurality of samples may include a first label, the first label may include one or more labels, and the plurality of samples included in the sample dataset may be image data, audio data, text data, or the like; dividing the sample dataset into K sample sub-datasets, determining a group of data from the K sample sub-datasets as a test dataset, and using sample sub-datasets other than the test dataset in the K sample sub-datasets as a train dataset, where K is an integer greater than 1; training the classifier by using the train dataset, and classifying the test dataset by using a trained classifier, to obtain a second label of each sample in the test dataset; obtaining a first indicator and a first hyper-parameter at least based on the first label and the second label, where the first indicator is a ratio of a quantity of samples each having a second label that is not equal to the first label in the test dataset to a total quantity of samples in the test dataset; obtaining a loss function of the classifier at least based on the first hyper-parameter, where the loss function is used to update the classifier; and completing training of the classifier when the first indicator meets a first preset condition. In the present disclosure, whether a model converges is determined by using the first indicator. The preset condition may be whether the first indicator reaches a preset threshold. When the first indicator reaches the threshold, the first hyper-parameter does not need to be updated. That is, the loss function does not need to be updated, and it may be considered that training of the classifier is completed. Alternatively, the preset condition may be alternatively determined based on results of successive iterative trainings. Specifically, if first indicators of the results of successive iterative trainings are the same, or fluctuation between the first indicators determined based on the results of successive iterative trainings is less than a preset threshold, the first hyper-parameter does not need to be updated. That is, the loss function does not need to be updated. It can be learned based on the first aspect that, the loss function of the classifier is obtained at least based on the first hyper-parameter. The loss function is used to update the classifier. In this way, impact of label noise can be alleviated. In addition, in the solution provided in the present disclosure, a classifier with a good classification effect can be obtained without requiring an additional clean dataset and additional manual annotation.

Optionally, with reference to the first aspect, in a first possible implementation, the first hyper-parameter is determined based on the first indicator and a second indicator, where the second indicator is an average value of loss values of all samples whose second label is not equal to the first label in the test dataset. It can be learned based on the first possible implementation of the first aspect that, a manner of determining the first hyper-parameter is provided, and the first hyper-parameter determined in this manner is used to update the loss function of the classifier. Then, the classifier is updated by using the loss function, to improve performance of the classifier. Specifically, accuracy of the classifier can be improved.

Optionally, with reference to the first possible implementation of the first aspect, in a second possible implementation, the first hyper-parameter γ is represented by using the following formula:

$$γ = a ( \frac{C *}{q *} - log b ) ,$$

where

C* represents the second indicator, q* represents the first indicator, a is greater than 0, and b is greater than 0.

Optionally, with reference to the first aspect, or the first or second possible implementation of the first aspect, in a third possible implementation, that a loss function of the classifier is obtained at least based on the first hyper-parameter may include: The loss function of the classifier is obtained at least based on the first hyper-parameter and a cross entropy.

Optionally, with reference to the third possible implementation of the first aspect, in a fourth possible implementation, the loss function y is represented by using the following formula:

y=γf(x)^{T}(1−eᵢ)+(−eᵢ^{T})log((fx)), where

eᵢ is used to represent a first vector corresponding to the first label of a first sample, f(x) is used to represent a second vector corresponding to the second label of the first sample, the first vector and the second vector have a same dimension, and the dimension of the first vector and the second vector is a quantity of categories of the samples in the test dataset.

Optionally, with reference to the first aspect or the first to the fourth possible implementations of the first aspect, in a fifth possible implementation, that the sample dataset is divided into K sample sub-datasets may include: The sample dataset is equally divided into the K sample sub-datasets.

Optionally, with reference to the first aspect or the first to the fifth possible implementations of the first aspect, in a sixth possible implementation, the classifier may include a convolutional neural network (CNN) and a residual network ResNet.

A second aspect of the present disclosure provides an example data processing method. The method may include: obtaining a dataset, where the dataset includes a plurality of samples, and each of the plurality of samples may include a first label; dividing the dataset into K sub-datasets, where K is an integer greater than 1; performing at least one classification on the dataset, to obtain first clean data of the dataset, where any classification in the at least one classification may include: determining a group of data from the K sub-datasets as a test dataset, and using sub-datasets other than the test dataset in the K sub-datasets as a train dataset; training the classifier by using the train dataset, and classifying the test dataset by using a trained classifier, to obtain a second label of each sample in the test dataset; and performing comparison based on the second label and the first label, to determine samples whose second label is equal to the first label in the test dataset, where the first clean data may include the samples whose second label is equal to the first label in the test dataset. It can be learned based on the second aspect that, by using the solution provided in the present disclosure, a noisy dataset may be filtered, to obtain clean data of the noisy dataset.

Optionally, with reference to the second aspect, in a first possible implementation, after the at least one classification is performed on the dataset, to obtain the first clean data of the dataset, the method may further include: The dataset is divided into M sub-datasets, where M is an integer greater than 1, and the M sub-datasets are different from the K sub-datasets. At least one classification is performed on the dataset, to obtain second clean data of the dataset, where any classification in the at least one classification may include: determining a group of data from the M sub-datasets as a test dataset, and using sub-datasets other than the test dataset in the M sub-datasets as a train dataset. The classifier is trained by using the train dataset, and the test dataset is classified by using the trained classifier, to obtain the second label of each sample in the test dataset. Comparison is performed based on the second label and the first label, to determine samples whose second label is equal to the first label in the test dataset, where the second clean data may include the samples whose second label is equal to the first label in the test dataset. Third clean data is determined based on the first clean data and the second clean data, where the third clean data is an intersection set between the first clean data and the second clean data. It can be learned based on the first possible implementation of the second aspect that, to achieve a better classification effect, that is, to obtain cleaner data, the dataset may be further redivided into groups, and clean data of the dataset is determined based on sub-datasets after redivision into groups.

A third aspect of the present disclosure provides an example data processing method. The data processing method may include: obtaining a dataset, where the dataset includes a plurality of samples, and each of the plurality of samples may include a first label; classifying the dataset by using a classifier, to determine a second label of each sample in the dataset; and determining samples whose second label is equal to the first label in the dataset as clean samples of the dataset, where the classifier is a classifier obtained through the training method according to the first aspect.

A fourth aspect of the present disclosure provides an example system for training a classifier. A data processing system may include a cloud-side device and a terminal-side device. The terminal-side device is configured to obtain a sample dataset, where the sample dataset may include a plurality of samples, and each of the plurality of samples may include a first label. The cloud-side device is configured to: divide the sample dataset into K sample sub-datasets, determine a group of data from the K sample sub-datasets as a test dataset, and use sample sub-datasets other than the test dataset in the K sample sub-datasets as a train dataset, where K is an integer greater than 1. The classifier is trained by using the train dataset, and the test dataset is classified by using a trained classifier, to obtain a second label of each sample in the test dataset. A first indicator and a first hyper-parameter are obtained at least based on the first label and the second label, where the first indicator is a ratio of a quantity of samples whose second label is not equal to the first label in the test dataset to a total quantity of samples in the test dataset. A loss function of the classifier is obtained at least based on the first hyper-parameter, and an updated classifier is obtained based on the loss function. Training of the classifier is completed when the first indicator meets a first preset condition.

A fifth aspect of the present disclosure provides an example data processing system, where the data processing system may include a cloud-side device and a terminal-side device. The terminal-side device is configured to obtain a dataset, where the dataset includes a plurality of samples, and each of the plurality of samples may include a first label. The cloud-side device is configured to divide the sample dataset into K sub-datasets, where K is an integer greater than 1. At least one classification is performed on the dataset, to obtain first clean data of the dataset, where any classification in the at least one classification may include: determining a group of data from the K sample sub-datasets as a test dataset, and using sample sub-datasets other than the test dataset in the K sample sub-datasets as a train dataset. The classifier is trained by using the train dataset, and the test dataset is classified by using a trained classifier, to obtain a second label of each sample in the test dataset. Comparison is performed based on the second label and the first label, to determine samples whose second label is equal to the first label in the test dataset, where the first clean data may include the samples whose second label is equal to the first label in the test dataset. The first clean data is sent to the terminal-side device.

A sixth aspect of the present disclosure provides an example apparatus for training a classifier. The apparatus may include: an obtaining module, configured to obtain a sample dataset, where the sample dataset may include a plurality of samples, and each of the plurality of samples may include a first label; a division module, configured to: divide the sample dataset into K sample sub-datasets, determine a group of data from the K sample sub-datasets as a test dataset, and use sample sub-datasets other than the test dataset in the K sample sub-datasets as a train dataset, where K is an integer greater than 1; and a training module, configured to: train the classifier by using the train dataset, and classify the test dataset by using a trained classifier, to obtain a second label of each sample in the test dataset; obtain a first indicator and a first hyper-parameter at least based on the first label and the second label, where the first indicator is a ratio of a quantity of samples whose second label is not equal to the first label in the test dataset to a total quantity of samples in the test dataset; obtain a loss function of the classifier at least based on the first hyper-parameter, and obtain an updated classifier based on the loss function; and complete training of the classifier when the first indicator meets a first preset condition.

Optionally, with reference to the sixth aspect, in a first possible implementation, the first hyper-parameter is determined based on the first indicator and a second indicator, where the second indicator is an average value of loss values of all samples whose second label is not equal to the first label in the test dataset.

Optionally, with reference to the first possible implementation of the sixth aspect, in a second possible implementation, the first hyper-parameter is represented by using the following formula:

$$γ = a ( \frac{C *}{q *} - log b ) ,$$

where

C* represents the second indicator, q* represents the first indicator, a is greater than 0, and b is greater than 0.

Optionally, with reference to the sixth aspect, or the first or second possible implementation of the sixth aspect, in a third possible implementation, the training module is specifically configured to obtain the loss function of the classifier at least based on a function that uses the first hyper-parameter as an independent variable and a cross entropy.

Optionally, with reference to the third possible implementation of the sixth aspect, in a fourth possible implementation, the function that uses the first hyper-parameter as the independent variable is represented by using the following formula:

y=γf(x)^{T}(1−eᵢ), where

eᵢ is used to represent a first vector corresponding to the first label of a first sample, f(x) is used to represent a second vector corresponding to the second label of the first sample, the first vector and the second vector have a same dimension, and the dimension of the first vector and the second vector is a quantity of categories of the samples in the test dataset.

Optionally, with reference to the sixth aspect or the first to the fourth possible implementations of the sixth aspect, in a fifth possible implementation, the division module is specifically configured to equally divide the sample dataset into the K sample sub-datasets.

Optionally, with reference to the sixth aspect or the first to the fifth possible implementations of the sixth aspect, in a sixth possible implementation, a quantity of a plurality of samples included in the train dataset is k times of a quantity of a plurality of samples included in the test dataset, and k is an integer greater than 0.

A seventh aspect of the present disclosure provides a data processing apparatus. The data processing apparatus may include: an obtaining module, configured to obtain a dataset, where the dataset includes a plurality of samples, and each of the plurality of samples may include a first label; a division module, configured to divide the sample dataset into K sub-datasets, where K is an integer greater than 1; and a classification module, configured to: perform at least one classification on the dataset, to obtain first clean data of the dataset, where any classification in the at least one classification may include: determining a group of data from the K sample sub-datasets as a test dataset, and using sample sub-datasets other than the test dataset in the K sample sub-datasets as a train dataset; train the classifier by using the train dataset, and classify the test dataset by using a trained classifier, to obtain a second label of each sample in the test dataset; and perform comparison based on the second label and the first label, to determine samples whose second label is equal to the first label in the test dataset, where the first clean data may include the samples whose second label is equal to the first label in the test dataset.

Optionally, with reference to the seventh aspect, in a first possible implementation, the division module is further configured to divide the sample dataset into M sub-datasets, where M is an integer greater than 1, and the M sub-datasets are different from the K sub-datasets; and the classification module is further configured to: perform at least one classification on the dataset, to obtain second clean data of the dataset, where any classification in the at least one classification may include: determining a group of data from the M sample sub-datasets as a test dataset, and using sample sub-datasets other than the test dataset in the M sample sub-datasets as a train dataset; train the classifier by using the train dataset, and classify the test dataset by using the trained classifier, to obtain a second label of each sample in the test dataset; perform comparison based on the second label and the first label, to determine samples whose second label is equal to the first label in the test dataset, where the second clean data may include the samples whose second label is equal to the first label in the test dataset; and determine third clean data based on the first clean data and the second clean data, where the third clean data is an intersection set between the first clean data and the second clean data.

An eighth aspect of the present disclosure provides an example data processing apparatus. The data processing apparatus may include: an obtaining module, configured to obtain a dataset, where the dataset includes a plurality of samples, and each of the plurality of samples may include a first label; and a classification module, configured to: classify the dataset by using a classifier, to determine a second label of each sample in the dataset; and determine samples whose second label is equal to the first label in the dataset as clean samples of the dataset, where the classifier is a classifier obtained through the training method according to any one of claims 1 to 7.

A ninth aspect of the present disclosure provides an example apparatus for training a classifier. The apparatus may include a processor and a memory. The processor is coupled to a memory, and the processor invokes program code in the memory to perform the method in the first aspect or any implementation of the first aspect.

A tenth aspect of the present disclosure provides an example data processing apparatus. The data processing apparatus may include a processor. The processor is coupled to a memory. The memory stores program instructions. When the program instructions stored in the memory are executed by the processor, the method in the second aspect or any implementation of the second aspect is implemented.

An eleventh aspect of the present disclosure provides an example computer-readable storage medium. The computer-readable storage medium may include a program. When the program is executed on a computer, the method in the first aspect or any implementation of the first aspect is performed.

A twelfth aspect of the present disclosure provides an example computer-readable storage medium. The computer-readable storage medium may include a program. When the program is executed on a computer, the method in the second aspect or any implementation of the second aspect is performed.

A thirteenth aspect of the present disclosure provides an example model training apparatus. The model training apparatus may include a processor and a communication interface, where the processor obtains program instructions through the communication interface, and when the program instructions are executed by the processor, the method in the first aspect or any implementation of the first aspect is implemented.

A fourteenth aspect of the present disclosure provides an example data processing apparatus. The data processing apparatus may include a processor and a communication interface. The processor obtains program instructions through the communication interface, and when the program instructions are executed by the processor, the method in the second aspect or any implementation of the second aspect is implemented.

### BRIEF DESCRIPTION OF DRAWINGS

FIG. 1 is a schematic diagram of an example artificial intelligence main framework to which the present disclosure is applied;

FIG. 2 is a schematic diagram of a structure of an example convolutional neural network according to an embodiment of the present disclosure;

FIG. 3 is a schematic diagram of a structure of another example convolutional neural network according to an embodiment of the present disclosure;

FIG. 4 is a schematic flowchart of an example method for training a classifier according to the present disclosure;

FIG. 5 is a schematic flowchart of another example method for training a classifier according to the present disclosure;

FIG. 6 is a schematic flowchart of another example method for training a classifier according to the present disclosure;

FIG. 7 is a schematic flowchart of an example data processing method according to the present disclosure;

FIG. 8 is a schematic flowchart of another example data processing method according to the present disclosure;

FIG. 9 is a schematic diagram of accuracy of an example data processing method according to an embodiment of the present disclosure;

FIG. 10 is a schematic diagram of a structure of an example apparatus for training a classifier according to an embodiment of the present disclosure;

FIG. 11 is a schematic diagram of a structure of an example data processing apparatus according to an embodiment of the present disclosure;

FIG. 12 is a schematic diagram of a structure of another example apparatus for training a classifier according to an embodiment of the present disclosure;

FIG. 13 is a schematic diagram of a structure of an example data processing apparatus according to an embodiment of the present disclosure; and

FIG. 14 is a schematic diagram of a structure of an example chip according to an embodiment of the present disclosure.

### DESCRIPTION OF EMBODIMENTS

The following describes technical solutions in embodiments of the present disclosure with reference to accompanying drawings in embodiments of the present disclosure. It is clearly that the described embodiments are merely a part rather than all of embodiments of the present disclosure. All other embodiments obtained by a person of ordinary skill in the art based on embodiments of the present disclosure without creative efforts shall fall within the protection scope of the present disclosure.

To better understand the technical solutions described in the present disclosure, the following explains key technical terms used in embodiments of the present disclosure:

Because embodiments of the present disclosure relate to massive application of a neural network, for ease of understanding, the following first describes terms and concepts related to the neural network in embodiments of the present disclosure.

(1) Neural Network

The neural network may include a neuron. The neuron may be an operation unit that uses xₛ and an intercept 1 as inputs, and an output of the operation unit may be shown in the following formula:

h_{w,b}(x)=f(W^{T}x)=f(Σₛ₌₁ⁿWₛxₛ+b)

Herein, s=1, 2, . . . , or n, n is a natural number greater than 1, Wₛ is a weight of xₛ, b is bias of the neuron, and f represents an activation function of the neuron. The activation function is used to introduce a non-linear characteristic into the neural network, to convert an input signal in the neuron into an output signal. The output signal of the activation function may be used as an input of a next convolutional layer, and the activation function may be a sigmoid function. The neural network is a network constituted by connecting a plurality of single neurons together. To be specific, an output of a neuron may be an input of another neuron. An input of each neuron may be connected to a local receptive field of a previous layer to extract a feature of the local receptive field. The local receptive field may be a region including several neurons.

There are a plurality of types of neural networks. For example, a deep neural network (DNN) is also referred to as a multi-layer neural network, that is, a neural network with a plurality of hidden layers. For another example, a convolutional neural network (CNN) is a deep neural network with a convolutional structure. A specific type of the used neural network is not limited in the present disclosure.

(2) Convolutional Neural Network

The convolutional neural network (CNN) is a deep neural network with a convolutional structure. The convolutional neural network includes a feature extractor constituted by a convolutional layer and a sub-sampling layer. The feature extractor may be considered as a filter. A convolution process may be considered as using a trainable filter to perform convolution on an input image or a convolutional feature map. The convolutional layer is a neuron layer for performing convolution processing on an input signal that is in the convolutional neural network. In the convolutional layer of the convolutional neural network, one neuron may be connected to only a part of neurons at a neighboring layer. A convolutional layer generally includes several feature maps, and each feature map may include some neurons arranged in a rectangle. Neurons of a same feature map share a weight, and the shared weight herein is a convolution kernel. Weight sharing may be understood as that a manner of extracting image information is unrelated to a location. A principle implied herein is that statistical information of a part of an image is the same as that of other parts. This means that image information learned in the part can also be used in the other parts. Therefore, same learned image information can be used for all locations in the image. At a same convolutional layer, a plurality of convolution kernels may be used to extract different image information. Usually, a larger quantity of convolution kernels indicates richer image information reflected by a convolution operation.

The convolution kernel may be initialized in a form of a matrix of a random size. In a training process of the convolutional neural network, an appropriate weight may be obtained for the convolution kernel through learning. In addition, a direct benefit of weight sharing is to reduce connections between the layers of the convolutional neural network while reducing a risk of overfitting.

(3) A recurrent neural network (RNN) is used for processing sequence data. In a conventional neural network model, from an input layer to a hidden layer and then to an output layer, the layers are fully connected, but nodes in each layer are not connected. Such a common neural network resolves many problems, but is still incapable of resolving many other problems. For example, to predict a next word in a sentence, a previous word usually needs to be used, because adjacent words in the sentence are not independent. A reason why the RNN is referred to as a recurrent neural network is that a current output of a sequence is related to a previous output. A specific representation form is that the network memorizes previous information and applies the previous information to calculation of the current output. To be specific, nodes in the hidden layer are no longer unconnected, but are connected, and an input for the hidden layer includes an output of the input layer and an output of the hidden layer at a previous moment. Theoretically, the RNN can process sequence data of any length. Training of the RNN is the same as training of a conventional CNN or DNN. An error back propagation algorithm is used, but a difference between the RNN and the example conventional neural network is: If the RNN is expanded, a parameter such as W of the RNN is shared. In addition, during use of a gradient descent algorithm, an output in each step depends not only on a network in the current step, but also on a network status in several previous steps. The learning algorithm is referred to as a back propagation through time (BPTT) algorithm.

A reason why the recurrent neural network is required when there is the convolutional neural network is simple. In the convolutional neural network, there is a premise that elements are independent of each other, and an input and an output are also independent, such as a cat and a dog. However, many elements are interconnected in the real world. For example, stocks change over time. For another example, a person says: I like traveling, a most favorite place is Yunnan, and I will go there in the future if there is a chance. If there is a blank to be filled herein, people should know that “Yunnan” is to be filled in. This is because people can make an inference from a context, but how can a machine do this? The RNN emerges. The RNN is designed to enable a machine to have a capability to remember like human beings. Therefore, an output of the RNN depends on current input information and historical memory information.

(4) Residual Network

When a depth of the neural network is increased continuously, a problem of degradation occurs. To be specific, with an increase in the depth of the neural network, accuracy rises first and then reaches saturation. After that, the continuous increase in the depth leads to a decrease in the accuracy. A biggest difference between a common directly connected convolutional neural network and a residual network (ResNet) lies in that the ResNet has many bypass branches that directly connect an input to a subsequent layer. Input information is directly transmitted to an output layer by making a detour, so that integrity of the information is protected, and the problem of degradation is resolved. The residual network includes a convolutional layer and/or a pooling layer.

The residual network may be as follows: A plurality of hidden layers in the deep neural network are connected to each other layer by layer. For example, a first hidden layer is connected to a second hidden layer, the second hidden layer is connected to a third hidden layer, and the third hidden layer is connected to a fourth hidden layer (this is a data operation path of the neural network, and may also be vividly referred to as neural network transmission). In addition, the residual network also includes a direct-connect branch. The direct-connect branch directly connects the first hidden layer to the fourth hidden layer. To be specific, data of the first hidden layer is directly transmitted to the fourth hidden layer for computation, without being processed by the second hidden layer and the third hidden layer. A highway network may be as follows: in addition to the foregoing operation path and direct-connect branch, the deep neural network further includes a weight obtaining branch. A transform gate is introduced into this branch to obtain a weight value, and output the weight value T to be used for subsequent operations performed by the foregoing operation path and direct-connect branch.

(5) Loss Function

In a process of training a deep neural network, it is expected that an output of the deep neural network is close, as much as possible, to a value that really needs to be predicted. Therefore, a predicted value of a current network and a really expected target value may be compared, and a weight vector of each layer of the neural network is updated (certainly, an initialization process is usually performed before updating for the first time, that is, a parameter is preconfigured for each layer in the deep neural network) based on a difference between the predicted value and the target value. For example, if a predicted value of the network is excessively high, a weight vector is adjusted to make the predicted value smaller, and adjustments are made continually until a really expected target value or a value that is quite close to the really expected target value can be predicted in the deep neural network. Therefore, “how to obtain, through comparison, a difference between the prediction value and the target value” needs to be predefined. This is a loss function or an objective function. The loss function and the objective function are important equations used to measure the difference between the prediction value and the target value. The loss function is used as an example. A higher output value (loss) of the loss function indicates a larger difference. Therefore, training of the deep neural network becomes a process of reducing the loss as much as possible.

(6) Hyper-Parameter

The hyper-parameter is a parameter whose value is set before a learning process is started, and is a parameter obtained without training. The hyper-parameter is used to adjust a training process of a neural network, for example, a quantity of hidden layers of a convolutional neural network, and a size and a quantity of kernel functions. The hyper-parameter does not directly participate in the training process, but is only used as a configuration variable. It should be noted that, the hyper-parameter is usually constant in the training process. Various neural networks used at present are trained by using data and a learning algorithm to obtain a model that can be used for prediction and estimation. If the model does not perform well, experienced workers adjust a network structure. A parameter that is obtained without training, such as a learning rate or a quantity of samples to be processed in each batch in the algorithm, is usually referred to as the hyper-parameter. Usually, the hyper-parameter is adjusted through a lot of practical experience to make the neural network model perform better until an output of the neural network meets a requirement. A group of hyper-parameter combinations mentioned in the present disclosure includes values of all or some of hyper-parameters of the neural network. Usually, the neural network includes many neurons, and input data is transmitted to an output end by using these neurons. During training of the neural network, a weight of each neuron is optimized based on a value of a loss function to reduce the value of the loss function. In this way, a parameter can be optimized by using an algorithm, to obtain a model. The hyper-parameter is used to adjust an entire network training process, for example, the foregoing quantity of hidden layers of a convolutional neural network, and the size or the quantity of kernel functions. The hyper-parameter does not directly participate in the training process, but is only used as a configuration variable.

A neural network optimization method provided in the present disclosure may be applied to an artificial intelligence (AI) scenario. AI uses a digital computer or a machine controlled by a digital computer to emulate and extend human intelligence, sense an environment, obtain knowledge, and use the knowledge to generate a best theory, method, technology, and application system. In other words, artificial intelligence is a branch of computer science, and is intended to understand the essence of intelligence and produce a new intelligent machine that can react in a manner similar to human intelligence. Artificial intelligence is to study design principles and implementation methods of various intelligent machines, so that the machines have perceiving, inference, and decision-making functions. Researches in the field of artificial intelligence include a robot, natural language processing, computer vision, decision-making and inference, human-computer interaction, recommendation and search, an AI basic theory, and the like.

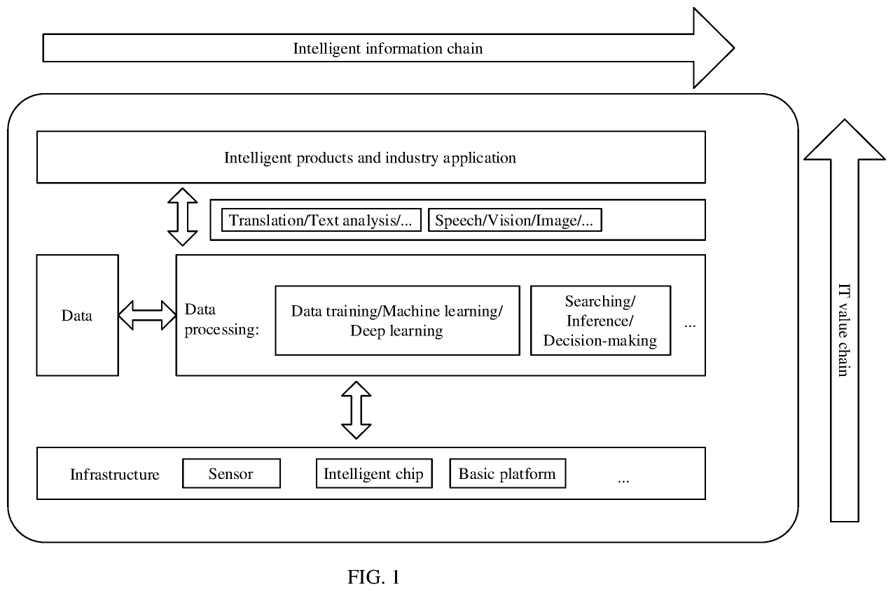

FIG. 1 is a schematic diagram of a non-limiting example artificial intelligence main framework. The main framework describes an overall working procedure of an artificial intelligence system, and is applicable to a requirement of a general artificial intelligence field.

The following describes the foregoing artificial intelligent main framework from two dimensions: an “intelligent information chain” (a horizontal axis) and an “IT value chain” (a vertical axis).

The “intelligent information chain” reflects a series of processes from obtaining data to processing the data. For example, the process may be a general process of intelligent information perception, intelligent information representation and formation, intelligent inference, intelligent decision-making, and intelligent execution and output. In this process, data undergoes a condensation process of “data-information-knowledge-wisdom”.

The “IT value chain” reflects a value brought by artificial intelligence to the information technology industry from an underlying infrastructure and information (technology providing and processing implementation) of human intelligence to an industrial ecological process of a system.

(1) Infrastructure

The infrastructure provides calculation capability support for the artificial intelligence system, communicates with an external world, and implements supporting by using a basic platform. The infrastructure communicates with the outside by using a sensor. A computing capability is provided by an intelligent chip, for example, a hardware acceleration chip such as a central processing unit (CPU), a neural-network processing unit (NPU), a graphics processing unit (GPU), an application-specific integrated circuit (ASIC), or a field programmable gate array (FPGA). The basic platform includes related platform assurance and support such as a distributed computing framework and a network, and may include cloud storage and computing, interconnected networks, and the like. For example, the sensor communicates with the outside to obtain data, and the data is provided, for computation, to an intelligent chip in a distributed computing system provided by the basic platform.

(2) Data

Data from a higher layer of the infrastructure is used to indicate a data source in the field of artificial intelligence. The data relates to a graph, an image, a voice, and text, further relates to internet of things data of a conventional device, and includes service data of an existing system and perception data such as force, displacement, a liquid level, a temperature, and humidity.

(3) Data Processing

The data processing usually includes manners such as data training, machine learning, deep learning, searching, inference, and decision-making.

The machine learning and the deep learning may mean performing symbolic and formalized intelligent information modeling, extraction, preprocessing, training, and the like on data.

Inference is a process of simulating intelligent human inference methods in computers or intelligent systems and using, according to an inference control policy, formalized information to carry out machine thinking and resolve problems, with search and matching being typical functions.

The decision-making is a process in which a decision is made after intelligent information inference, and usually provides functions such as classification, ranking, and prediction.

(4) General Capabilities

After data processing mentioned above is performed on data, some general capabilities may be further formed based on a data processing result, for example, an algorithm or a general system, such as translation, text analysis, computer vision processing, speech recognition, and image recognition.

(5) Intelligent Product and Industry Application

The intelligent products and industry applications are products and applications of the artificial intelligence system in various fields, and are package of an overall solution of artificial intelligence, so that decision-making for smart information is productized and an application is implemented. Application fields mainly include smart manufacturing, smart transportation, smart home, smart health care, smart security protection, autonomous driving, a safe city, a smart terminal, and the like.

In the foregoing scenario, the neural network is used as an important node to implement machine learning, deep learning, searching, inference, decision-making, and the like. The neural network mentioned in the present disclosure may include a plurality of types, for example, a deep neural network (DNN), a convolutional neural network (CNN), a recurrent neural network (RNN), a residual network, or another neural network. Some neural networks are described by way of example below.

The neural network may include a neuron. The neuron may be an operation unit that uses Xₛs and an intercept of 1 as inputs, where an output of the operation unit may be as follows:

h_{W,b}(x)=f(W^{T}x)=f(Σₛ₌₁ⁿWₛxₛ+b)

Herein, s=1, 2, . . . , or n, n is a natural number greater than 1, W_{S} is a weight of x_{S}, b is bias of the neuron, and f represents an activation function of the neuron. The activation function is used to introduce a non-linear characteristic into the neural network, to convert an input signal in the neuron into an output signal. The output signal of the activation function may be used as an input of a next convolutional layer. The activation function may be sigmoid, a rectified linear unit (ReLU), tanh, or another function. The neural network is a network constituted by connecting a plurality of single neurons together. To be specific, an output of a neuron may be an input of another neuron. An input of each neuron may be connected to a local receptive field of a previous layer to extract a feature of the local receptive field. The local receptive field may be a region including several neurons.

The convolutional neural network (CNN) is a deep neural network with a convolutional structure. The convolutional neural network includes a feature extractor constituted by a convolutional layer and a sub-sampling layer. The feature extractor may be considered as a filter. A convolution process may be considered as using a trainable filter to perform convolution on an input image or a convolutional feature map. The convolutional layer is a neuron layer for performing convolution processing on an input signal that is in the convolutional neural network. In the convolutional layer of the convolutional neural network, one neuron may be connected to only a part of neurons at a neighboring layer. A convolutional layer generally includes several feature maps, and each feature map may include some neurons arranged in a rectangle. Neurons of a same feature map share a weight, and the shared weight herein is a convolution kernel. Weight sharing may be understood as that a manner of extracting image information is unrelated to a location. A principle implied herein is that statistical information of a part of an image is the same as that of other parts. This means that image information learned in the part can also be used in the other parts. Therefore, image information obtained through same learning can be used for all locations on the image. At a same convolutional layer, a plurality of convolution kernels may be used to extract different image information. Usually, a larger quantity of convolution kernels indicates richer image information reflected by a convolution operation.

The convolution kernel may be initialized in a form of a matrix of a random size. In a training process of the convolutional neural network, an appropriate weight may be obtained for the convolution kernel through learning. In addition, a direct benefit of weight sharing is to reduce connections between the layers of the convolutional neural network while reducing a risk of overfitting.

An error back propagation (BP) learning algorithm may be used in a convolutional neural network to modify a value of a parameter in an initial super-resolution model in a training process, so that a reconstruction error loss for the super-resolution model becomes smaller. Specifically, an error loss occurs during forward propagation and output of an input signal. In this case, error loss information is back-propagated to update the parameter in the initial super-resolution model, so that the error loss converges. The back propagation algorithm is an error loss-oriented back propagation process with an objective of obtaining an optimal parameter for the super-resolution model, such as a weight matrix.

For example, the following uses a convolutional neural network (CNN) as an example.

The CNN is a deep neural network with a convolutional structure, and is a deep learning architecture. The deep learning architecture means that a machine learning algorithm is used to perform multi-level learning at different abstraction levels. As the deep learning architecture, the CNN is a feed-forward artificial neural network. Neurons in the feed-forward artificial neural network respond to an overlapping region in images input into the CNN.

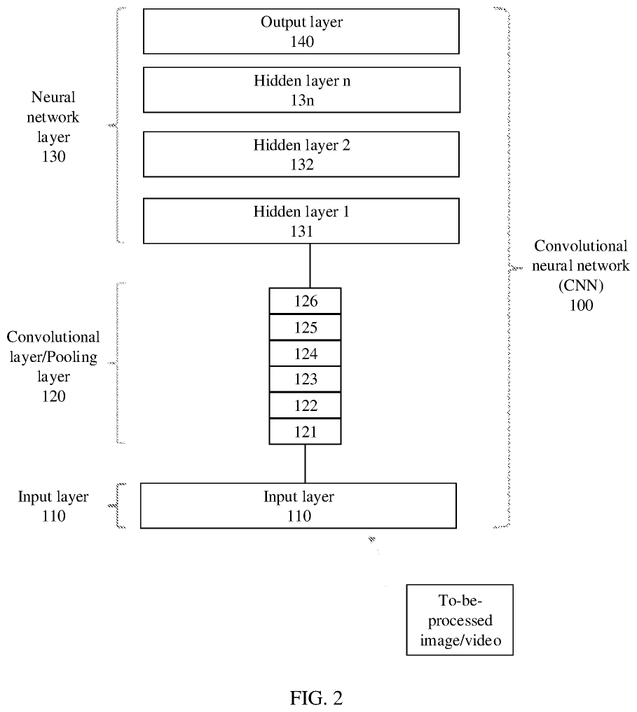

As shown in FIG. 2, a convolutional neural network (CNN) 100 may include an input layer 110, a convolutional layer/pooling layer 120, and a neural network layer 130. The pooling layer is optional.

As shown in FIG. 2, the convolutional layer/pooling layer 120 may include, for example, layers 121 to 126. In an implementation, the layer 121 is a convolutional layer, the layer 122 is a pooling layer, the layer 123 is a convolutional layer, the layer 124 is a pooling layer, the layer 125 is a convolutional layer, and the layer 126 is a pooling layer. In another implementation, the layers 121 and 122 are convolutional layers, the layer 123 is a pooling layer, the layers 124 and 125 are convolutional layers, and the layer 126 is a pooling layer. In other words, an output of a convolutional layer may be used as an input for a subsequent pooling layer, or may be used as an input for another convolutional layer, to continue to perform a convolution operation.

The convolutional layer 121 is used as an example. The convolutional layer 121 may include a plurality of convolution operators. The convolution operator is also referred to as a kernel. In image processing, the convolution operator functions as a filter that extracts specific information from an input image matrix. The convolution operator may be a weight matrix essentially, and the weight matrix is usually predefined. During a convolution operation on an image, the weight matrix is usually processed on the input image pixel by pixel (or two pixels by two pixels, . . . , which depends on a value of a stride) along a horizontal direction, to extract specific features from the image. A size of the weight matrix is related to a size of the image. It should be noted that a depth dimension of the weight matrix is the same as a depth dimension of the input image. In a convolution operation process, the weight matrix extends to an entire depth of the input image. Therefore, a convolution output of a single depth dimension is generated by performing convolution with a single weight matrix. However, in most cases, a plurality of weight matrices of a same dimension rather than a single weight matrix are applied. Outputs of the weight matrices are stacked to form a depth dimension of a convolutional image. Different weight matrices may be used to extract different features from the image. For example, one weight matrix is used to extract edge information of the image, another weight matrix is used to extract a specific color of the image, and a further weight matrix is used to blur unneeded noise in the image. The plurality of weight matrices have a same dimension, feature maps extracted by the plurality of weight matrices having the same dimension also have a same dimension, and then the plurality of extracted feature maps having the same dimension are combined to form an output of the convolution operation.

Weight values in these weight matrices need to be obtained in actual application through massive training The weight matrices that are formed based on the weight values obtained through training may be used to extract information from the input image, to help the convolutional neural network 100 perform correct prediction.

When the convolutional neural network 100 includes a plurality of convolutional layers, a larger quantity of general features are usually extracted at an initial convolutional layer (for example, the convolutional layer 121). The general features may also be referred to as low-level features. As a depth of the convolutional neural network 100 increases, a feature extracted at a more subsequent convolutional layer (for example, the convolutional layer 126) is more complex, for example, a high-level semantic feature. A feature with higher semantics is more applicable to a to-be-resolved problem.

Pooling Layer:

A quantity of training parameters often needs to be reduced. Therefore, a pooling layer often needs to be periodically introduced after a convolutional layer. For the layers 121 to 126 shown in the convolutional layer/pooling layer 120 in FIG. 2, one convolutional layer may be followed by one pooling layer, or a plurality of convolutional layers may be followed by one or more pooling layers. During image processing, the pooling layer is only used to reduce a space size of an image. The pooling layer may include an average pooling operator and/or a maximum pooling operator, to perform sampling on an input image to obtain an image with a relatively small size. The average pooling operator may calculate a pixel value in an image in a specific range, to generate an average value. The maximum pooling operator may be used to select a pixel with a maximum value in a specific range as a maximum pooling result. In addition, just as the size of the weight matrix should be related to the size of the image at the convolutional layer, an operator also needs to be related to a size of an image at the pooling layer. A size of a processed image output from the pooling layer may be less than a size of an image input into the pooling layer. Each pixel in the image output from the pooling layer represents an average value or a maximum value of a corresponding sub-region of the image input into the pooling layer.

Neural Network Layer 130:

After processing is performed at the convolutional layer/pooling layer 120, the convolutional neural network 100 still cannot output required output information. As described above, at the convolutional layer/pooling layer 120, only a feature is extracted, and parameters resulting from an input image are reduced. However, to generate final output information (required type information or other related information), the convolutional neural network 100 needs to use the neural network layer 130 to generate an output of one required type or a group of required types. Therefore, the neural network layer 130 may include a plurality of hidden layers (131, and 132 to 13n shown in FIG. 2), and an output layer 140. In the present disclosure, the convolutional neural network is obtained in the following manner Delaying an output of a prediction model is used as a constraint to search a super unit to obtain at least one first construction unit, and then the at least one first construction unit is stacked. The convolutional neural network may be used for image recognition, image classification, image super resolution reconstruction, and the like.

At the neural network layer 130, the plurality of hidden layers are followed by the output layer 140, namely, the last layer of the entire convolutional neural network 100. The output layer 140 has a loss function similar to categorization cross entropy, and the loss function is specifically used to calculate a prediction error. Once forward propagation (that is, propagation in a direction from 110 to 140, as shown in FIG. 2) of the entire convolutional neural network 100 is completed, back propagation (that is, propagation in a direction from 140 to 110, as shown in FIG. 2) is started to update a weight value and a deviation of each layer mentioned above, so as to reduce a loss of the convolutional neural network 100 and an error between a result output by the convolutional neural network 100 through the output layer and an ideal result.

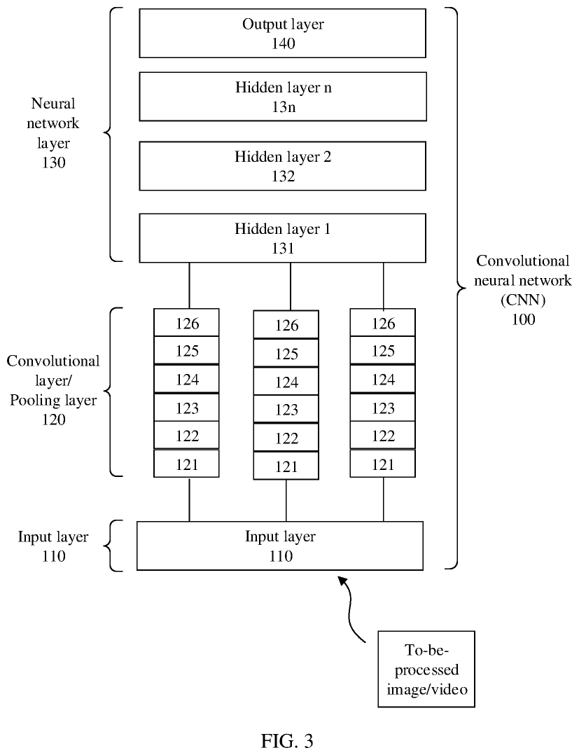

It should be noted that the convolutional neural network 100 shown in FIG. 2 is merely used as an example of a convolutional neural network. In specific application, the convolutional neural network may alternatively exist in a form of another network model. For example, a plurality of convolutional layers or pooling layers shown in FIG. 3 are concurrent, and extracted features are all input to the neural network layer 130 and processed.

Usually, for supervised learning, quality of a label corresponding to train data plays a vital role in a learning effect. If label data used in learning is incorrect, it is difficult to obtain an effective prediction model. However, in actual application, many datasets contain noise, that is, labels of data are incorrect. There are many reasons for noise in datasets, including: Manual annotation is incorrect, there is an error in a data collection process, or it is difficult to ensure label quality by obtaining a label through online inquiry of a customer.

A common practice of processing a noisy label is to constantly check a dataset to identify a sample with an incorrect label, and correct the label of the sample. However, this solution usually requires a lot of manpower to correct labels. If a manner of correcting labels by using a result predicted by a model is used, it is difficult to ensure quality of a re-annotated label. In addition, some other solutions are to design a noise robust loss function or use a noise detection algorithm to filter out noisy samples and delete the noisy samples. In some of the methods, noise distribution is assumed and the methods are applicable only to some particular noise distribution cases. As a result, it is difficult to ensure a classification effect. Alternatively, a clean dataset is required for assistance. However, in actual application, it is usually difficult to obtain a piece of clean data. Implementation of this solution has a bottleneck.

Therefore, the present disclosure provides a model training method, which is used to filter a clean dataset from a noisy dataset. The noisy dataset means that labels of some of the data are incorrect.

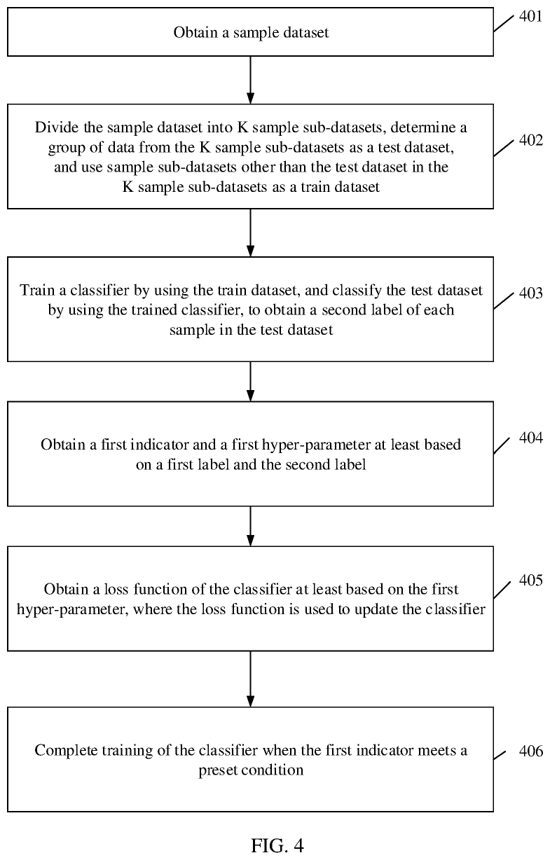

FIG. 4 is a schematic flowchart of a method for training a classifier according to an embodiment of the present disclosure. Details are as follows:

401: Obtain a sample dataset.

The sample dataset includes a plurality of samples, and each of the plurality of samples includes a first label.

The plurality of samples included in the sample dataset may be image data, audio data, text data, or the like. This is not limited in this embodiment of the present disclosure.

Each of the plurality of samples includes the first label. The first label may include one or more labels. It should be noted that, in the present disclosure, the label is also sometimes referred to as a category label. When a difference between these two labels is not emphasized, these two labels indicate a same meaning.

That the first label may include one or more labels is described by using an example in which the plurality of samples are image data. Assuming that the sample dataset includes a plurality of pieces of image sample data, and the sample dataset is classified by using a single label, in this scenario, each piece of image sample data corresponds to only one category label, that is, has a unique semantic meaning. In this scenario, it may be considered that the first label includes one label. In more scenarios, in consideration of semantic diversity of an object, the object is very likely to be related to a plurality of different category labels at the same time, or a plurality of related category labels are usually used to describe semantic information corresponding to each object. Using the image sample data as an example, the image sample data may be related to a plurality of different category labels at the same time. For example, one piece of image sample data may correspond to a plurality of labels at the same time, for example, “grassland”, “sky”, and “sea”, and the first label may include “grassland”, “sky”, and “sea”. In this scenario, it may be considered that the first label includes a plurality of labels.

402: Divide the sample dataset into K sample sub-datasets, determine a group of data from the K sample sub-datasets as a test dataset, and use sample sub-datasets other than the test dataset in the K sample sub-datasets as a train dataset.

K is an integer greater than 1. For example, assuming that the sample dataset includes 1000 samples, and K is 5, the 1000 samples may be classified into five groups of sample sub-datasets (or five sample sub-datasets, and quantifiers used in this embodiment do not affect essence of the solution). The five groups of sample sub-datasets are respectively a first sample sub-dataset, a second sample sub-dataset, a third sample sub-dataset, a fourth sample sub-dataset, and a fifth sample sub-dataset. Any one of the five groups of sample sub-datasets may be selected as the test dataset, and the sample sub-datasets other than the test dataset are used as the train dataset. For example, the first sample sub-dataset may be selected as the test dataset, and the second sample sub-dataset, the third sample sub-dataset, the fourth sample sub-dataset, and the fifth sample sub-dataset are used as the train dataset. For another example, the second sample sub-dataset may be selected as the test dataset, and the first sample sub-dataset, the third sample sub-dataset, the fourth sample sub-dataset, and the fifth sample sub-dataset are used as the train dataset.

In a possible implementation, the sample dataset may be equally divided into K sample sub-datasets. For example, using the foregoing 1000 pieces of sample data as an example, after equal division, the first sample sub-dataset, the second sample sub-dataset, the third sample sub-dataset, the fourth sample sub-dataset, and the fifth sample sub-dataset include a same quantity of samples. For example, each of the first sample sub-dataset, the second sample sub-dataset, the third sample sub-dataset, the fourth sample sub-dataset, and the fifth sample sub-dataset includes 200 pieces of sample data. It should be noted that, in actual application, because a quantity of samples included in the sample dataset may be quite huge, if a difference between quantities of samples included in the K sample sub-datasets is within a particular range, it may be considered that the sample dataset is equally divided into K sample sub-datasets. For example, if the first sample sub-dataset includes 10000 samples, the second sample sub-dataset includes 10005 samples, the third sample sub-dataset includes 10020 samples, and the fourth sample sub-dataset includes 10050 samples, it may be considered that the first sample sub-dataset, the second sample sub-dataset, the third sample sub-dataset, and the fourth sample sub-dataset are equally divided.

In a possible implementation, K is an integer greater than 2 and less than 20.

403: Train the classifier by using the train dataset, and classify the test dataset by using a trained classifier, to obtain a second label of each sample in the test dataset.

For example, when a label includes an image category, image sample data in the train dataset may be classified by using a deep neural network model, to obtain a predicted category of a sample, namely, a predicted label. The predicted category or the predicted label is the second label used in the solution of the present disclosure.

The classifier provided in the present disclosure may be a plurality of neural networks. In the present disclosure, the classifier is also sometimes referred to as a neural network model, or a model in short. When a difference between these two is not emphasized, these two indicate a same meaning. In a possible implementation, the classifier provided in the present disclosure may be a CNN. Specifically, the classifier may be a four-layer CNN (4-layer CNN). For example, the neural network may include two convolutional layers and two fully-connected layers. Several fully-connected layers are connected at the end of the convolutional neural network to integrate previously extracted features. Alternatively, the classifier provided in the present disclosure may alternatively be an eight-layer CNN (8-layer CNN). For example, the neural network may include six convolutional layers and two fully-connected layers. Alternatively, the classifier provided in the present disclosure may alternatively be a ResNet, for example, a ResNet-44. A structure of the ResNet can extremely accelerate training of a super-deep neural network, and accuracy of the model also increases significantly. It should be noted that, the classifier provided in the present disclosure may alternatively be another neural network model. The aforementioned several neural network models are only used as several preferred solutions.

The following explains and describes the second label. The neural network model may include an output layer. The output layer may include a plurality of output functions. Each output function is used to output a predicted result of a corresponding label, for example, a category, such as a predicted label or a predicted probability corresponding to the predicted label. For example, the output layer of the deep network model may include m output functions, for example, a Sigmoid function, and m is a quantity of labels corresponding to a multi-label image training set. For example, when the label is a category, m is a quantity of categories of the multi-label image training set, and is a positive integer. An output of each output function, for example, the Sigmoid function may include a probability that a given training image belongs to a particular label, for example, an object category, and/or a probability value, namely, the predicted probability. For example, assuming that the sample dataset has a total of 10 categories, one sample in the test dataset is input into the classifier, and the model predicts that a probability that the sample belongs to a first category is p1, and a probability that the sample belongs to a second category is p2, a predicted probability is f(x)=[p1, p2, . . . , p10]. It may be considered that a category corresponding to the largest probability is the predicted label of the sample. For example, assuming that P3 is the largest, a third category corresponding to P3 is the predicted label of the sample.

404: Obtain a first indicator and a first hyper-parameter at least based on the first label and the second label.

The first indicator is a ratio of a quantity of samples whose second label is not equal to the first label in the test dataset to a total quantity of samples in the test dataset. In other words, the first indicator is a probability that the second label is not equal to the first label, and may be determined by dividing the quantity of samples whose second label is not equal to the first label by the total quantity of samples. In the present disclosure, the first indicator is also sometimes referred to as an expected probability value. When a difference between these two indicators is not emphasized, these two indicators indicate a same meaning. Assuming that the test dataset includes 1000 samples, and each of the 1000 samples corresponds to one first label, namely, an observed label, second labels of the 1000 samples, namely, predicted labels, may be output by using the classifier. Whether an observed label is equal to a predicted label of each sample may be separately compared. Being equal may be understood as that the observed label is completely the same as the predicted label, or a difference between values corresponding to the observed label and the predicted label is within a particular range. Assuming that there are 800 samples whose first label is equal to the second label in the 1000 samples, and there are 200 samples whose first label is not equal to the second label, the first indicator may be determined based on the 200 samples and the 1000 samples. The first hyper-parameter is obtained at least based on the first label and the second label, to update the loss function.

405: Obtain a loss function of the classifier at least based on the first hyper-parameter, where the loss function is used to update the classifier.

A higher output value (loss) of the loss function indicates a larger difference. A training process of the classifier is a process of minimizing the loss. In the solution provided in the present disclosure, the loss function of the classifier is obtained at least based on the first hyper-parameter. During iterative training, the first hyper-parameter may be continuously updated based on the second label obtained through iterative training each time, and the first hyper-parameter may be used to determine the loss function of the classifier.

406: Complete training of the classifier when the first indicator meets a preset condition.

In the present disclosure, whether a model converges is determined by using the first indicator. The preset condition may be whether the first indicator reaches a preset threshold. When the first indicator reaches the threshold, the first hyper-parameter does not need to be updated. That is, the loss function does not need to be updated, and it may be considered that the training of the classifier is completed. Alternatively, the preset condition may be alternatively determined based on results of successive iterative trainings. Specifically, if first indicators of the results of successive iterative trainings are the same, or fluctuation between the first indicators determined based on the results of successive iterative trainings is less than a preset threshold, the first hyper-parameter does not need to be updated. That is, the loss function does not need to be updated.

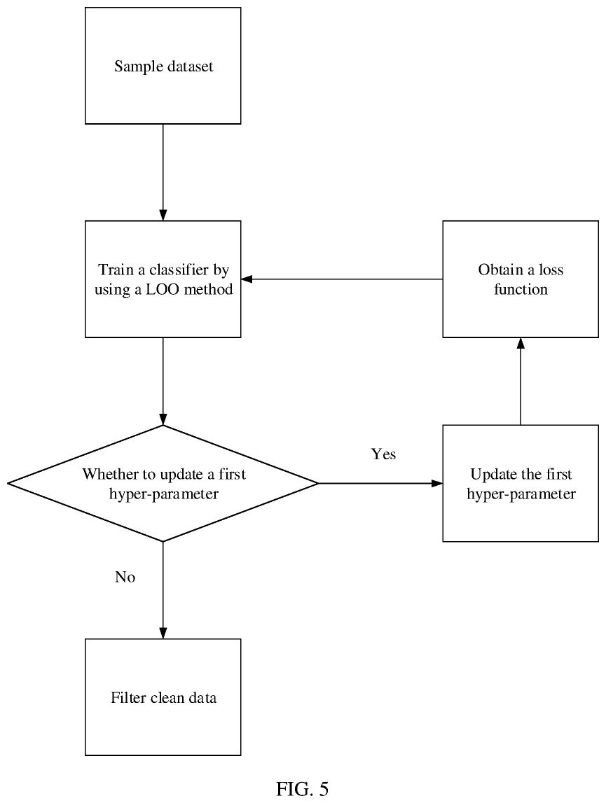

To better reflect the solution provided in the present disclosure, the following describes the training process of the classifier in this embodiment with reference to FIG. 5.

FIG. 5 is a schematic flowchart of another method for training a classifier according to an embodiment of the present disclosure. As shown in FIG. 5, a sample dataset is first obtained, where the sample dataset may also be referred to as a noisy dataset, because labels of samples included in the sample dataset may be incorrect. The classifier is trained through leave-one-out (LOO). LOO is a method for training and testing the classifier, and uses all sample data in the sample dataset. Assuming that the dataset has K sample sub-datasets (K1, K2, . . . , Kn), the K sample sub-datasets are divided into two parts. The first part includes K−1 sample sub-datasets for training the classifier, and the other part includes one sample sub-dataset for testing. In this way, iteration is performed for n times from K1 to Kn, and all objects in all the samples undergo testing and training. Whether a first hyper-parameter needs to be updated is determined. In a possible implementation, whether the first hyper-parameter needs to be updated is determined based on a first indicator, for example, whether the first hyper-parameter needs to be updated is determined based on whether the first indicator meets a preset condition. For example, when the first indicator does not meet the preset condition, it is considered that the first hyper-parameter needs to be updated; or when the first indicator meets the preset condition, it is considered that the first hyper-parameter does not need to be updated. When the first indicator does not meet the preset condition, the first hyper-parameter needs to be updated in this case. In a possible implementation, the first hyper-parameter may be determined based on a first label and a second label, where the second label is determined based on a result output after iterative training each time. Then, a loss function of the classifier is determined based on the first hyper-parameter that meets the preset condition, where the loss function is used to update a parameter of the classifier. When the first indicator meets the preset condition, the first hyper-parameter does not need to be updated in this case, and it may be considered that the loss function of the classifier determines that the trained classifier can be used to filter clean data. For example, the example listed in step 402 is still used for description. The sample dataset is divided into five groups. The five groups of sample sub-datasets are respectively a first sample sub-dataset, a second sample sub-dataset, a third sample sub-dataset, a fourth sample sub-dataset, and a fifth sample sub-dataset. For example, the first sample sub-dataset is selected as a first test dataset, and the second sample sub-dataset, the third sample sub-dataset, the fourth sample sub-dataset, and the fifth sample sub-dataset are selected as a first train dataset. Then, the classifier is trained by using the first train dataset, and clean data of the first sample sub-dataset can be output, and the loss function of the classifier can be determined at the same time. Then, the classifier is separately trained by using a second train dataset, a third train dataset, a fourth train dataset, and a fifth train dataset to output clean data of the second sample sub-dataset, clean data of the third sample sub-dataset, clean data of the fourth sample sub-dataset, and clean data of the fifth sample sub-dataset. It should be noted that, when the classifier is trained by using the second train dataset, the third train dataset, the fourth train dataset, and the fifth train dataset, the loss function of the classifier has been determined, and only a parameter of the classifier needs to be adjusted based on the loss function, to output clean data corresponding to the test dataset. The second train dataset includes the first sample sub-dataset, the third sample sub-dataset, the fourth sample sub-dataset, and the fifth sample sub-dataset. The third train dataset includes the first sample sub-dataset, the second sample sub-dataset, the fourth sample sub-dataset, and the fifth sample sub-dataset. The fourth train dataset includes the first sample sub-dataset, the second sample sub-dataset, the third sample sub-dataset, and the fifth sample sub-dataset. The fifth train dataset includes the first sample sub-dataset, the second sample sub-dataset, the third sample sub-dataset, and the fourth sample sub-dataset.

It can be learned based on the embodiments corresponding to FIG. 4 and FIG. 5 that, in the solution provided in the present disclosure, the loss function of the classifier is obtained at least based on the first hyper-parameter. The loss function is used to update the classifier. In this way, impact of label noise can be alleviated. In addition, in the solution provided in the present disclosure, a classifier with a good classification effect can be obtained without requiring an additional clean dataset and additional manual annotation.

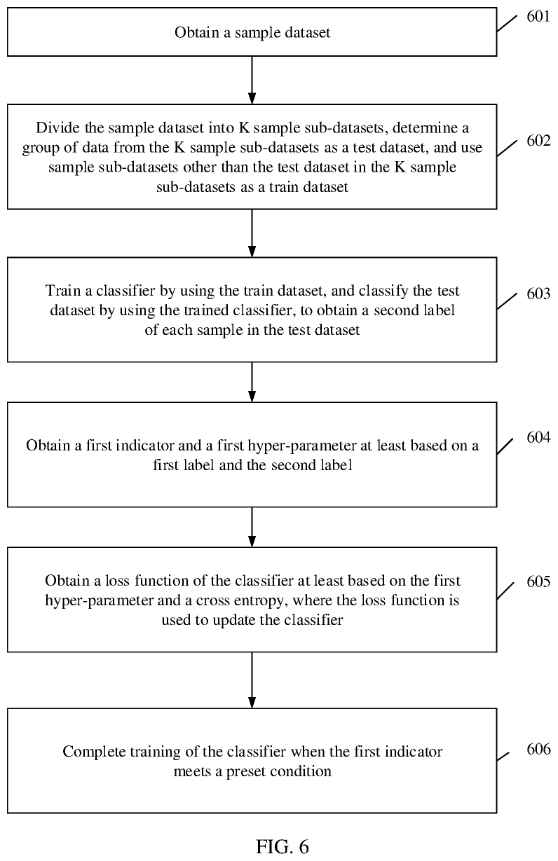

FIG. 6 is a schematic flowchart of another example method for training a classifier according to an embodiment of the present disclosure.

As shown in FIG. 6, the other example method for training a classifier provided in the present disclosure may include the following steps.

601: Obtain a sample dataset.

602: Divide the sample dataset into K sample sub-datasets, determine a group of data from the K sample sub-datasets as a test dataset, and use sample sub-datasets other than the test dataset in the K sample sub-datasets as a train dataset.

603: Train the classifier by using the train dataset, and classify the test dataset by using a trained classifier, to obtain a second label of each sample in the test dataset.

Step 601 to step 603 may be understood with reference to steps 401 to 403 in the embodiment corresponding to FIG. 4, and details are not described herein again.

604: Obtain a first indicator and a first hyper-parameter at least based on the first label and the second label.

The first hyper-parameter is determined based on the first indicator and a second indicator, where the second indicator is an average value of loss values of all samples whose second label is not equal to the first label in the test dataset.

In a possible implementation, the first hyper-parameter may be represented by using the following formula:

$$γ = a ( \frac{C *}{q *} - log b ) ,$$

where

C* represents the second indicator, q* represents the first indicator, a is greater than 0, and b is greater than 0.

605: Obtain a loss function of the classifier at least based on the first hyper-parameter and a cross entropy, where the loss function is used to update the classifier.

The loss function may include two parts: one is a cross entropy and the other is a function that uses the first hyper-parameter as an independent variable. The cross entropy may also be referred to as a cross entropy loss function. The cross entropy loss function may be used to determine a difference of probability distribution of a predicted label. The cross entropy loss function may be represented by using the following formula: l_{ce}=−eᵢ^{T} log(f(x)), where

eᵢ is used to represent a first vector corresponding to the first label of a first sample, f(x) is used to represent a second vector corresponding to the second label of the first sample, the first vector and the second vector have a same dimension, and the dimension of the first vector and the second vector is a quantity of categories of the samples in the test dataset. For example, if the sample dataset has a total of 10 categories, and the model predicts that a probability that a sample x belongs to a first category is p1, and a probability that the sample x belongs to a second category is p2, f(x)=[p1, p2, . . . , p10]. eᵢ is a vector whose dimension is equal to a quantity of categories. For example, if the sample dataset has a total of 10 categories, the eᵢ dimension is 10. If an observed label of the sample x is the second category, eᵢ=[0, 1, 0, 0, 0, . . . , 0], and i=2.

The function that uses the first hyper-parameter as the independent variable may be represented by using the following formula:

lₙᵢₚ=γf(x)^{T}(1−eᵢ)

In a possible implementation, the loss function may be represented by using the following formula:

y=γf(x)^{T}(1−eᵢ)+(−eᵢ^{T})log(f(x))

606: Complete training of the classifier when the first indicator meets a preset condition.

Step 606 may be understood with reference to step 406 in the embodiment corresponding to FIG. 4. Details are not described herein again.

It can be learned from the embodiment corresponding to FIG. 6 that, a specific expression manner of the loss function is provided, and diversity of solutions is increased.

It can be learned from the embodiments shown in FIG. 4 to FIG. 6 that, in the solution provided in the present disclosure, the sample dataset is divided into the K sample sub-datasets, and a group of data is determined from the K sample sub-datasets as the test dataset. It should be noted that this solution is a preferred solution provided in this embodiment. In some embodiments, in the present disclosure, at least one group of data may be further determined as the test dataset. For example, two or three groups of data may be determined as the test dataset, and sample sub-datasets other than the test dataset in the sample dataset are used as the train dataset. In other words, in the solution provided in the present disclosure, K−1 groups of data may be selected as the train dataset, and the remaining group of data may be selected as the test dataset, or at least one group of data may be selected as the test dataset, and a data group other than the test dataset in the dataset may be selected as the train dataset. For example, K−2 groups of data may be alternatively selected as the train dataset, and the remaining two groups of data may be selected as the test dataset, or K−3 groups of data may be alternatively selected as the train dataset, and the remaining three groups of data may be selected as the test dataset, and so on.

The sample dataset in the present disclosure is a noisy dataset. To be specific, in the plurality of samples included in the sample dataset, observed labels of some samples are incorrect. In the present disclosure, noise may be added to a noise-free dataset, to obtain the noisy dataset. For example, assuming that a clean dataset includes 100 samples, and observed labels of the 100 samples are all correct by default, predicted labels of one or more samples in the 100 samples may be replaced with labels other than original labels in a manual modification manner, to obtain the noisy dataset. For example, if a label of a sample is a cat, the label of the sample may be replaced with a label other than the cat, for example, the label of the sample may be replaced with a mouse. In a possible implementation, the clean dataset may be any one of MNIST, CIFAR-10, and CIFAR-100 datasets. The MNIST dataset includes 60,000 examples for training and 10,000 examples for testing. The CIFAR-10 dataset includes a total of 10 categories of RGB color pictures, and the CIFAR-10 dataset includes a total of 50,000 training pictures and 10,000 testing pictures. The CIFAR-100 dataset includes 60000 pictures from 100 categories, and each category includes 600 pictures.

The foregoing describes how to train the classifier, and the following describes how to use the trained classifier to perform classification.

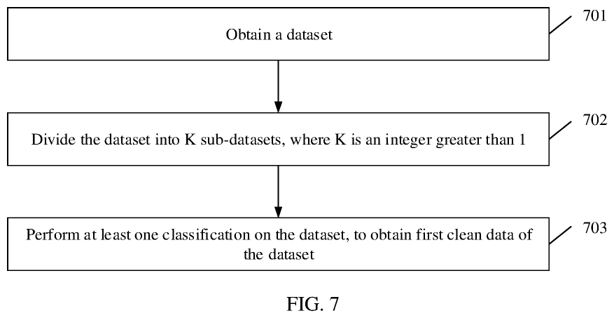

FIG. 7 is a schematic flowchart of a data processing method according to an embodiment of the present disclosure.

As shown in FIG. 7, an example data processing method provided in this embodiment may include the following steps.

701: Obtain a dataset.

The dataset includes a plurality of samples, and each of the plurality of samples includes a first label.

702: Divide the dataset into K sub-datasets, where K is an integer greater than 1.

In a possible implementation, the dataset may be equally divided into K sub-datasets. In another implementation, the dataset may alternatively not be equally divided into K sub-datasets.

703: Perform at least one classification on the dataset, to obtain first clean data of the dataset.

Any classification in the at least one classification includes:

determining a group of data from the K sub-datasets as a test dataset, and using sub-datasets other than the test dataset in the K sub-datasets as a train dataset.

The classifier is trained by using the train dataset, and the test dataset is classified by using a trained classifier, to obtain a second label of each sample in the test dataset.

Comparison is performed based on the second label and the first label, to determine samples whose second label is equal to the first label in the test dataset, where the first clean data includes the samples whose second label is equal to the first label in the test dataset.

A process of training the classifier by using the train dataset may be understood with reference to the methods for training the classifier in FIG. 4 and FIG. 5. Details are not described herein again.

For example, assuming that the dataset includes 1000 samples and K is 5, the dataset is divided into five sub-datasets. It is assumed that in this example, the 1000 samples are equally classified into five sub-datasets, which are respectively a first sub-dataset, a second sub-dataset, a third sub-dataset, a fourth sub-dataset, and a fifth sub-dataset, and each sub-dataset includes 200 samples. Assuming that the first sub-dataset is the test dataset, and the second sub-dataset, the third sub-dataset, the fourth sub-dataset, and the fifth sub-dataset are the train dataset, the classifier is trained by using the train dataset. If training of the classifier is completed, the test dataset is classified by using the classifier whose training is completed. Whether training of the classifier is completed may be determined based on whether a first indicator meets a preset condition. For example, assuming that the classifier is obtained through training by using the second sub-dataset, the third sub-dataset, the fourth sub-dataset, and the fifth sub-dataset as the train dataset, the first sub-dataset is classified by using a first classifier, to output predicted labels of 200 samples included in the first sub-dataset. The second sub-dataset, the third sub-dataset, the fourth data subset, and the fifth sub-dataset are used as the train dataset to train the classifier, to determine the loss function of the classifier. The loss function may be used in a subsequent training process of the classifier. During subsequent training, the loss function is unchanged, the test dataset and the train dataset are changed in turn, and a parameter of the classifier is determined separately for each change, and a piece of clean data is output. The trained classifier separately outputs predicted labels of the first sub-dataset, the second sub-dataset, the third sub-dataset, the fourth sub-dataset, and the fifth sub-dataset, namely, second labels. Then, a clean sample of the dataset is determined based on whether the predicted label is equal to an observed label, that is, whether the second label is equal to the first label. The first sub-dataset is used as an example for description. Assuming that it is determined, through comparison between the second labels and the first labels of the first sub-dataset, that there are 180 samples whose second label is equal to the first label in the first sub-dataset, it is determined that the 180 samples in the first sub-dataset are clean data. In this way, clean data of the second sub-dataset, the third sub-dataset, the fourth sub-dataset, and the fifth sub-dataset can be determined, and a combination of the five pieces of clean data is clean data of the dataset.

In a possible implementation, to achieve a better classification effect, that is, to obtain cleaner data, the dataset may be further redivided into groups, and the clean data of the dataset is determined based on sub-datasets after redivision into groups. Details are described below.

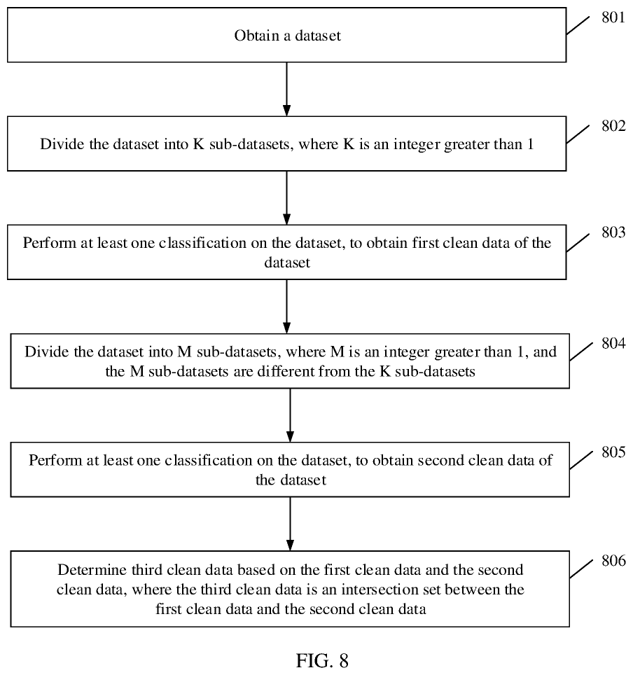

FIG. 8 is a schematic flowchart of an example data processing method according to an embodiment of the present disclosure.

As shown in FIG. 8, a data processing method provided in this embodiment may include the following steps.

801: Obtain a dataset.

802: Divide the dataset into K sub-datasets, where K is an integer greater than 1.

803: Perform at least one classification on the dataset, to obtain first clean data of the dataset.

Step 801 to step 803 may be understood with reference to step 701 to step 703 in the embodiment corresponding to FIG. 7, and details are not described herein again.

804: Divide the dataset into M sub-datasets, where M is an integer greater than 1, and the M sub-datasets are different from the K sub-datasets. M may be equal to K, or may be not equal to K.

805: Perform at least one classification on the dataset, to obtain second clean data of the dataset.

Any classification in the at least one classification includes:

determining a group of data from the M sub-datasets as a test dataset, and using sub-datasets other than the test dataset in the M sub-datasets as a train dataset.

The classifier is trained by using the train dataset, and the test dataset is classified by using a trained classifier, to obtain a second label of each sample in the test dataset.

Comparison is performed based on the second label and the first label, to determine samples whose second label is equal to the first label in the test dataset, where the second clean data includes the samples whose second label is equal to the first label in the test dataset.

806: Determine third clean data based on the first clean data and the second clean data, where the third clean data is an intersection set between the first clean data and the second clean data.

In other words, steps 702 and 703 in the embodiment corresponding to FIG. 7 may be repeatedly performed. A quantity of times of repeated execution may be preset. For example, steps 702 and 703 may be repeatedly performed for P times, and P is an integer greater than 1, and P pieces of clean data corresponding to the dataset can be obtained. In P datasets, samples whose quantity t of times of appearance is greater than 2 are selected as a final clean dataset. A classifier model with a good effect is obtained through training by using the final clean dataset.

It should be noted that, a category of an object in the dataset in the embodiments described in FIG. 7 and FIG. 8 may be completely different from a category of an object included in the sample dataset used for training the model in FIG. 4 and FIG. 5. In other words, a to-be-classified dataset may be unrelated to the dataset used for training the model. In a possible implementation, if the category of the object included in the sample dataset used for training the model in FIG. 4 and FIG. 5 covers the category of the object included in the to-be-classified dataset, the classifier obtained through training in FIG. 4 and FIG. 5 may be directly used to classify the dataset. Retraining is not required to obtain the classifier. For example, in this implementation, the following steps may be included:

1: Obtain a dataset, where the dataset includes a plurality of samples, and each of the plurality of samples includes a first label.

2: Classify the dataset by using a classifier, to determine a second label of each sample in the dataset.

3: Determine samples whose second label is equal to the first label in the dataset as clean samples of the dataset.

It should be noted that the technical solution provided in the present disclosure may be implemented in a terminal-cloud combination manner. An example is as follows:

In a specific implementation, for the embodiment corresponding to FIG. 4, step 401 may be performed by a terminal-side device, and step 402 to step 406 may be performed by a cloud-side device or by the terminal-side device. Alternatively, step 401 and step 402 are performed by the terminal-side device, and step 403 to step 406 may be performed by the cloud-side device or by the terminal-side device. It should be noted that, in a possible implementation, an original sample dataset obtained by the terminal-side device may not include the first label. In this case, the sample dataset with the first label may be obtained in a manual annotation manner or an automatic annotation manner. This manner may also be considered as that the terminal device obtains the sample dataset. In a possible implementation, the automatic annotation process may be alternatively performed by the cloud-side device. This is not limited in embodiments of the present disclosure, and details are not described below again.

For the embodiment corresponding to FIG. 6, step 601 may be performed by the terminal-side device, and step 602 to step 606 may be performed by the cloud-side device or by the terminal-side device. For example, step 601 and step 602 may be performed by the terminal-side device, and after completing step 602, the terminal-side device may send a result to the cloud-side device. Step 603 to step 606 may be performed by the cloud-side device. In a specific implementation, after completing step 606, the cloud-side device may return a result of step 605 to the terminal-side device.

For the embodiment corresponding to FIG. 7, step 701 may be performed by the terminal-side device, step 702 and step 703 are performed by the cloud-side device, or step 701 and step 702 are performed by the terminal-side device, and step 703 is performed by the cloud-side device.

For the embodiment corresponding to FIG. 8, step 801 may be performed by the terminal-side device, and step 802 to step 806 may be performed by the cloud-side device, or step 801 and step 802 are performed by the terminal-side device, and step 803 to step 806 are performed by the cloud-side device.

For example, the following separately uses MNIST, CIFAR-10, and CIFAR-100 datasets whose noise ratios are 0, 0.2, 0.4, 0.6, and 0.8 as input data of a neural network, and compares the data processing method provided in the present disclosure with a common solution. Beneficial effects of the data processing method provided in the present disclosure are described by using examples.

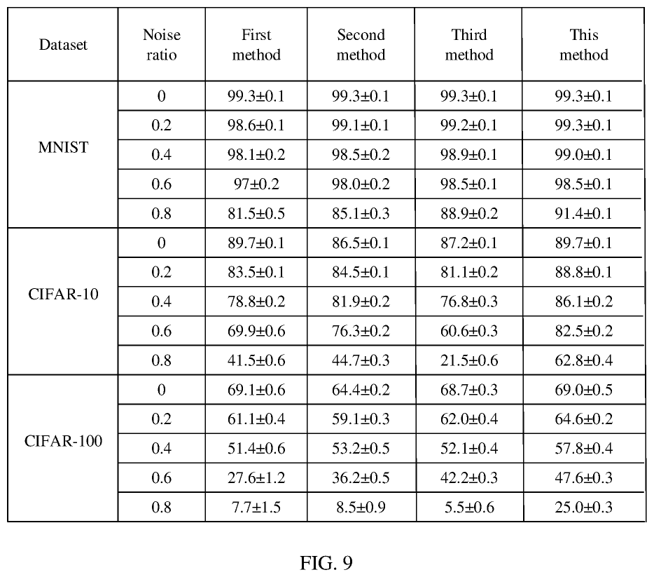

FIG. 9 is a schematic diagram of accuracy of a data processing method according to an embodiment of the present disclosure.

Refer to FIG. 9. Effects of several existing classification methods and the data processing method provided in the present disclosure are compared and described. The first method in FIG. 9 is a method for updating a classifier only by using a cross entropy loss function, and a loss function in the present disclosure combines the cross entropy loss function and a loss function that is determined based on a first hyper-parameter. The second method is a method for updating the classifier by using generalized cross entropy loss (GCE), and the third method is dimensionality-driven learning with noisy labels (D2L). In the several existing manners, the classifier trained only by using the cross entropy loss function and the classifier trained by using the generalized cross entropy loss have poor effects for classifying a dataset, and the D2L improves anti-noise performance of a model. In the solution provided in the present disclosure, a clean dataset corresponding to a noisy dataset is first output, and then a model is trained based on the clean dataset. In this case, the cross entropy loss function is used, so that a good classification effect can be achieved.

It can be learned from FIG. 9 that, in the data processing method provided in the present disclosure, the loss function combines the cross entropy loss function and the loss function that is determined based on the first hyper-parameter, and when the data processing method is applied to a neural network, classification accuracy is higher than that in some common manners. Therefore, the data processing method provided in the present disclosure can achieve a better classification effect.

The foregoing describes, in detail, the training process of a classifier and the data processing method that are provided in the present disclosure. The following describes, based on the foregoing method for training a classifier and the data processing method, an apparatus for training a classifier and a data processing apparatus that are provided in the present disclosure. The apparatus for training a classifier is configured to perform the steps of the methods corresponding to FIG. 4 to FIG. 6, and the data processing apparatus is configured to perform the steps of the methods corresponding to FIG. 7 and FIG. 8.

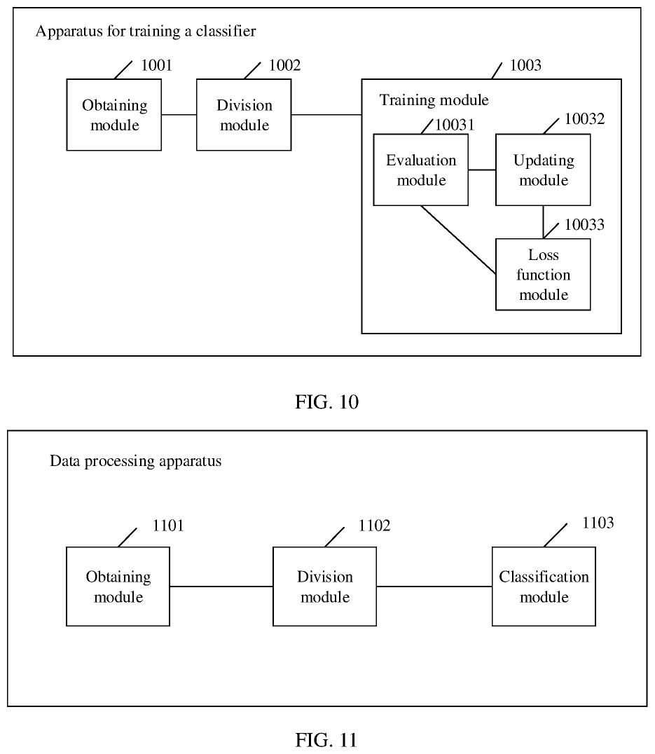

FIG. 10 is a schematic diagram of a structure of an apparatus for training a classifier according to an embodiment of the present disclosure. The apparatus for training a classifier includes:

an obtaining module 1001, configured to obtain a sample dataset, where the sample dataset may include a plurality of samples, and each of the plurality of samples may include a first label; a division module 1002, configured to: divide the sample dataset into K sample sub-datasets, determine a group of data from the K sample sub-datasets as a test dataset, and use sample sub-datasets other than the test dataset in the K sample sub-datasets as a train dataset, where K is an integer greater than 1; and a training module 1003, configured to: train the classifier by using the train dataset, and classify the test dataset by using a trained classifier, to obtain a second label of each sample in the test dataset; obtain a first indicator and a first hyper-parameter at least based on the first label and the second label, where the first indicator is a ratio of a quantity of samples whose second label is not equal to the first label in the test dataset to a total quantity of samples in the test dataset; obtain a loss function of the classifier at least based on the first hyper-parameter, and obtain an updated classifier based on the loss function; and complete training of the classifier when the first indicator meets a first preset condition.

In another example implementation, the training module 1003 may be further divided into an evaluation module 10031, an updating module 10032, and a loss function module 10033. The evaluation module 10031 is configured to evaluate whether the first indicator meets the first preset condition. The updating module is configured to update the first hyper-parameter when the first indicator does not meet the first preset condition. The loss function module is configured to obtain the loss function of the classifier based on the updated first hyper-parameter.

In a possible implementation, the first hyper-parameter is determined based on the first indicator and a second indicator, where the second indicator is an average value of loss values of all samples whose second label is not equal to the first label in the test dataset.

In a possible implementation, the first hyper-parameter is represented by using the following formula:

$$γ = a ( \frac{C *}{q *} - log b ) ,$$

where

C* represents the second indicator, q* represents the first indicator, a is greater than 0, and b is greater than 0.

In a possible implementation, the training module 1003 is specifically configured to obtain the loss function of the classifier at least based on a function that uses the first hyper-parameter as an independent variable and a cross entropy.

In a possible implementation, the function that uses the first hyper-parameter as the independent variable is represented by using the following formula:

y=γf(x)^{T}(1−eᵢ), where

eᵢ is used to represent a first vector corresponding to the first label of a first sample, f(x) is used to represent a second vector corresponding to the second label of the first sample, the first vector and the second vector have a same dimension, and the dimension of the first vector and the second vector is a quantity of categories of the samples in the test dataset.

In a possible implementation, the obtaining module 1001 is specifically configured to equally divide the sample dataset into the K sample sub-datasets.

In a possible implementation, a quantity of a plurality of samples included in the train dataset is k times of a quantity of a plurality of samples included in the test dataset, and k is an integer greater than 0.

FIG. 11 is a schematic diagram of a structure of a data processing apparatus according to an embodiment of the present disclosure. The data processing apparatus includes:

an obtaining module 1101, configured to obtain a dataset, where the dataset includes a plurality of samples, and each of the plurality of samples may include a first label; a division module 1102, configured to divide the sample dataset into K sub-datasets, where K is an integer greater than 1; and a classification module 1103, configured to: perform at least one classification on the dataset, to obtain first clean data of the dataset, where any classification in the at least one classification may include: determining a group of data from the K sample sub-datasets as a test dataset, and using sample sub-datasets other than the test dataset in the K sample sub-datasets as a train dataset; train the classifier by using the train dataset, and classify the test dataset by using a trained classifier, to obtain a second label of each sample in the test dataset; and perform comparison based on the second label and the first label, to determine samples whose second label is equal to the first label in the test dataset, where the first clean data may include the samples whose second label is equal to the first label in the test dataset.

In a possible implementation, the division module 1102 is further configured to divide the sample dataset into M sub-datasets, where M is an integer greater than 1, and the M sub-datasets are different from the K sub-datasets; and the classification module 1103 is further configured to: perform at least one classification on the dataset, to obtain second clean data of the dataset, where any classification in the at least one classification may include: determining a group of data from the M sample sub-datasets as a test dataset, and using sample sub-datasets other than the test dataset in the M sample sub-datasets as a train dataset; train the classifier by using the train dataset, and classify the test dataset by using the trained classifier, to obtain a second label of each sample in the test dataset; perform comparison based on the second label and the first label, to determine samples whose second label is equal to the first label in the test dataset, where the second clean data may include the samples whose second label is equal to the first label in the test dataset; and determine third clean data based on the first clean data and the second clean data, where the third clean data is an intersection set between the first clean data and the second clean data.

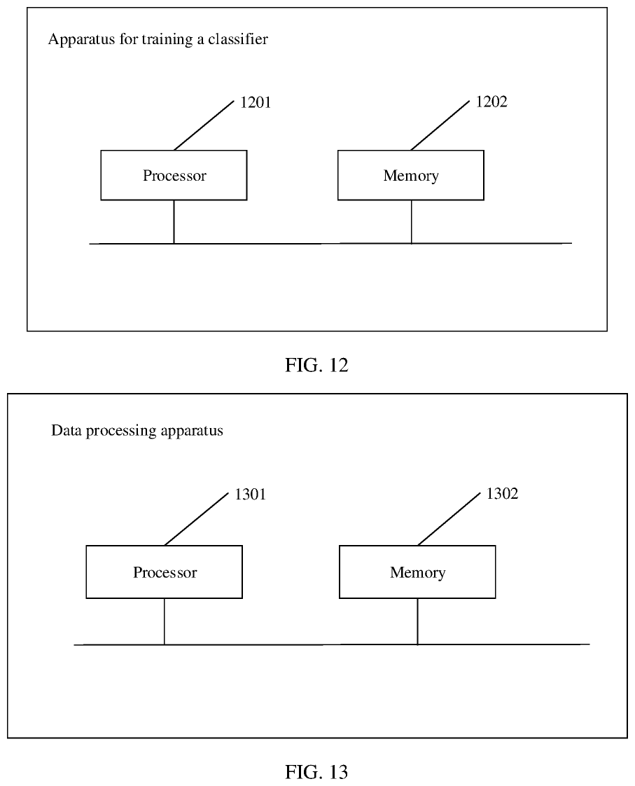

FIG. 12 is a schematic diagram of a structure of another apparatus for training a classifier according to an embodiment of the present disclosure. Details are as follows:

The apparatus for training a classifier may include a processor 1201 and a memory 1202. The processor 1201 and the memory 1202 are interconnected through a line. The memory 1202 stores program instructions and data.

The memory 1202 stores the program instructions and the data that correspond to the steps in FIG. 4 to FIG. 6.

The processor 1201 is configured to perform the method steps performed by the apparatus for training a classifier in any one of the embodiments of FIG. 4 to FIG. 6.

FIG. 13 is a schematic diagram of a structure of another data processing apparatus according to an embodiment of the present disclosure. Details are as follows:

The apparatus for training a classifier may include a processor 1301 and a memory 1302. The processor 1301 and the memory 1302 are interconnected through a line. The memory 1302 stores program instructions and data.

The memory 1302 stores the program instructions and the data that correspond to the steps in FIG. 7 or FIG. 8.

The processor 1301 is configured to perform the method steps performed by the data processing apparatus in the embodiment of FIG. 7 or FIG. 8.

An embodiment of the present disclosure further provides a computer-readable storage medium. The computer-readable storage medium stores a program used to generate a classifier for training. When the program is run on a computer, the computer is enabled to perform the steps in the methods described in the embodiments shown in FIG. 4 to FIG. 6.

An embodiment of the present disclosure further provides a computer-readable storage medium. The computer-readable storage medium stores a program used to generate data for processing. When the program is run on a computer, the computer is enabled to perform the steps in the method described in the embodiment shown in FIG. 7 or FIG. 8.

An embodiment of the present disclosure further provides an apparatus for training a classifier. The apparatus for training a classifier may also be referred to as a digital processing chip or a chip. The chip includes a processor and a communication interface. The processor obtains program instructions through the communication interface. The program instructions are executed by the processor. The processor is configured to perform the method steps performed by the apparatus for training a classifier in any embodiment of FIG. 4 or FIG. 6.

An embodiment of the present disclosure further provides a data processing apparatus. The data processing apparatus may also be referred to as a digital processing chip or a chip. The chip includes a processor and a communication interface. The processor obtains program instructions through the communication interface. The program instructions are executed by the processor. The processor is configured to perform the method steps performed by the data processing apparatus in the embodiment of FIG. 7 or FIG. 8.

An embodiment of the present disclosure further provides a digital processing chip. A circuit and one or more interfaces that are configured to implement the processor 1201 or a function of the processor 1201 are integrated into the digital processing chip. When a memory is integrated into the digital processing chip, the digital processing chip may complete the method steps in any one or more of the foregoing embodiments. When a memory is not integrated into the digital processing chip, the digital processing chip may be connected to an external memory through a communication interface. The digital processing chip implements the actions executed by the apparatus for training a classifier in the foregoing embodiment based on program code stored in the external memory.

An embodiment of the present disclosure further provides a digital processing chip. A circuit and one or more interfaces that are configured to implement the processor 1301 or a function of the processor 1301 are integrated into the digital processing chip. When a memory is integrated into the digital processing chip, the digital processing chip may complete the method steps in any one or more of the foregoing embodiments. When a memory is not integrated into the digital processing chip, the digital processing chip may be connected to an external memory through a communication interface. The digital processing chip implements, based on program code stored in the external memory, the actions performed by the apparatus for training a classifier in the foregoing embodiments.

An embodiment of the present disclosure further provides a computer program product. When the computer program product runs on a computer, the computer is enabled to perform the steps performed by the apparatus for training a classifier in the method described in the embodiments shown in FIG. 4 to FIG. 6, or to perform the steps performed by the data processing apparatus in the method described in the embodiment shown in FIG. 7 or FIG. 8.

The apparatus for training a classifier or the data processing apparatus provided in this embodiment of the present disclosure may be a chip. The chip includes a processing unit and a communication unit. The processing unit may be, for example, a processor, and the communication unit may be, for example, an input/output interface, a pin, or a circuit. The processing unit can execute computer executable instructions stored in a storage unit, so that a chip in a server performs the method for training a classifier described in the embodiments shown in FIG. 4 to FIG. 6, or the data processing method described in the embodiments shown in FIG. 7 and FIG. 8. Optionally, the storage unit may be a storage unit in the chip, such as a register or a buffer, or the storage unit may be a storage unit in the radio access device end but outside the chip, such as a read-only memory (ROM) or another type of static storage device capable of storing static information and instructions, or a random access memory (RAM).

Specifically, the processing unit or the processor may be a central processing unit (CPU), a network processor (neural-network processing unit, NPU), a graphics processing unit (GPU), a digital signal processor (DSP), an application-specific integrated circuit (ASIC), a field programmable gate array (FPGA), another programmable logic device, a discrete gate, a transistor logic device, a discrete hardware component, or the like. A general-purpose processor may be a microprocessor, or may be any conventional processor, or the like.

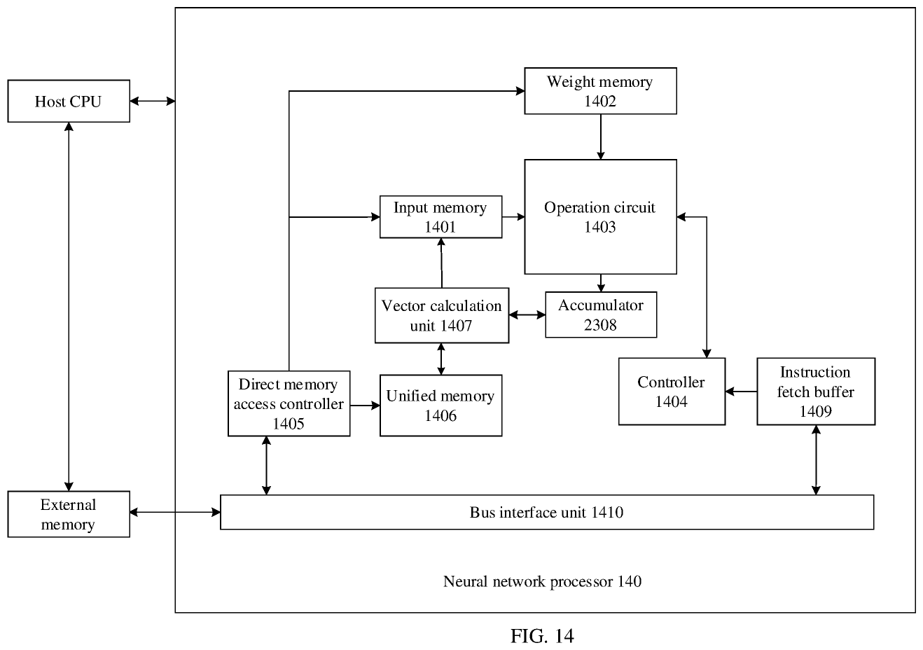

Specifically, FIG. 14 is a schematic diagram of a structure of a chip according to an embodiment of the present disclosure. The chip may be represented as a neural-network processing unit (NPU) 1400. The NPU 1400 is mounted to a host CPU as a coprocessor, and the host CPU allocates a task. A core part of the NPU is an operation circuit 1403. The operation circuit 1403 is controlled by a controller 1404 to extract matrix data in a memory and perform a multiplication operation.

In some implementations, the operation circuit 1403 includes a plurality of processing engines (PE). In some implementations, the operation circuit 1403 is a two-dimensional systolic array. The operation circuit 1403 may alternatively be a one-dimensional systolic array or another electronic circuit capable of performing mathematical operations such as multiplication and addition. In some implementations, the operation circuit 1403 is a general-purpose matrix processor.

For example, it is assumed that there are an input matrix A, a weight matrix B, and an output matrix C. The operation circuit fetches, from a weight memory 1402, data corresponding to the matrix B, and buffers the data on each PE in the operation circuit. The operation circuit fetches data of the matrix A from an input memory 1401, to perform a matrix operation on the matrix B, and stores an obtained partial result or an obtained final result of the matrix in an accumulator 1408.

A unified memory 1406 is configured to store input data and output data. The weight data is directly transferred to the weight memory 1402 by using a direct memory access controller (DMAC) 1405. The input data is also transferred to the unified memory 1406 by using the DMAC.

A bus interface unit (BIU) 1410 is used for interaction between an AXI bus and the DMAC and an instruction fetch buffer (IFB) 1409.

The bus interface unit (BIU) 1410 is used by the instruction fetch buffer 1409 to obtain instructions from an external memory, and is further used by the direct memory access controller 1405 to obtain original data of the input matrix A or the weight matrix B from the external memory.

The DMAC is mainly configured to transfer input data in the external memory DDR to the unified memory 1406, or transfer weight data to the weight memory 1402, or transfer input data to the input memory 1401.

A vector calculation unit 1407 includes a plurality of operation processing units; and if necessary, performs further processing such as vector multiplication, vector addition, an exponential operation, a logarithmic operation, or value comparison on an output of the operation circuit. The vector calculation unit 1407 is mainly configured to perform network calculation at a non-convolutional/fully connected layer in a neural network, for example, batch normalization, pixel-level summation, and upsampling on a feature map.

In some implementations, the vector calculation unit 1407 can store a processed output vector in the unified memory 1406. For example, the vector calculation unit 1407 may apply a linear function and/or a non-linear function to the output of the operation circuit 1403, for example, perform linear interpolation on a feature map extracted at a convolutional layer, and for another example, accumulate vectors of values to generate an activation value. In some implementations, the vector calculation unit 1407 generates a normalized value, a value obtained after pixel-level summation, or a combination thereof. In some implementations, the processed output vector can be used as an activated input to the operation circuit 1403. For example, the processed output vector can be used at a subsequent layer in the neural network.

The instruction fetch buffer 1409 connected to the controller 1404 is configured to store instructions used by the controller 1404.

The unified memory 1406, the input memory 1401, the weight memory 1402, and the instruction fetch buffer 1409 are all on-chip memories. The external memory is private for a hardware architecture of the NPU.

An operation at each layer in the recurrent neural network may be performed by the operation circuit 1403 or the vector calculation unit 1407.

Any processor mentioned above may be a general-purpose central processing unit, a microprocessor, an ASIC, or one or more integrated circuits configured to control execution of programs of the methods of FIG. 4 to FIG. 6, or integrated circuits configured to control execution of programs of the methods of FIG. 7 and FIG. 8.

In addition, it should be noted that the described apparatus embodiment is merely an example. The units described as separate parts may or may not be physically separate, and parts displayed as units may or may not be physical units, that is, may be located in one place, or may be distributed on a plurality of network units. Some or all the modules may be selected based on an actual need to achieve the objectives of the solutions of the embodiments. In addition, in the accompanying drawings of the apparatus embodiments provided in the present disclosure, connection relationships between modules indicate that the modules have communication connections with each other, which may be specifically implemented as one or more communication buses or signal cables.

Based on the description of the foregoing implementations, a person skilled in the art may clearly understand that the present disclosure may be implemented by using software in combination with necessary universal hardware, or certainly, may be implemented by using dedicated hardware, including a dedicated integrated circuit, a dedicated CPU, a dedicated memory, a dedicated component, or the like. Generally, any function that can be completed by using a computer program can be very easily implemented by using corresponding hardware. Moreover, a specific hardware structure used to implement a same function may be in various forms, for example, in a form of an analog circuit, a digital circuit, a dedicated circuit, or the like. However, as for the present disclosure, software program implementation is a better implementation in most cases. Based on such an understanding, the technical solutions of the present disclosure essentially or the part contributing to the conventional technology may be implemented in a form of a software product. The computer software product is stored in a readable storage medium, such as a floppy disk, a USB flash drive, a removable hard disk, a read-only memory (ROM), a random access memory (RAM), a magnetic disk, or an optical disc of a computer, and includes several instructions for instructing a computer device (which may be a personal computer, a server, a network device, or the like) to perform the methods described in embodiments of the present disclosure.

All or some of the foregoing embodiments may be implemented by using software, hardware, firmware, or any combination thereof. When software is used to implement the embodiments, all or some of the embodiments may be implemented in a form of a computer program product.

The computer program product includes one or more computer instructions. When the computer program instructions are loaded and executed on a computer, all or some of the procedures or functions according to embodiments of the present disclosure are generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state disk, SSD)), or the like.

In this specification, the claims, and the accompanying drawings of the present disclosure, terms “first”, “second”, “third”, “fourth”, and the like (if existent) are intended to distinguish between similar objects but do not necessarily indicate a specific order or sequence. It should be understood that the data termed in such a way is interchangeable in an appropriate circumstance, so that the embodiments described herein can be implemented in another order than the order illustrated or described herein. Moreover, terms “include”, “have”, and any other variants thereof mean to cover non-exclusive inclusion. For example, a process, method, system, product, or device that includes a list of steps or units is not necessarily limited to those steps or units, but may include other steps or units not expressly listed or inherent to such a process, method, product, or device.

Finally, it should be noted that the foregoing descriptions are merely non-limiting example implementations of the present disclosure, but are not intended to limit the protection scope, which is intended to cover any variation or replacement readily determined by a person of ordinary skill in the art. Therefore, the claims shall define the protection scope.

What is claimed is:

1. A training method for training a classifier, comprising:
obtaining a sample dataset, wherein the sample dataset comprises a plurality of samples, and each of the plurality of samples comprises a first label;
dividing the sample dataset into K sample sub-datasets, determining a group of data from the K sample sub-datasets as a test dataset, and using sample sub-datasets other than the test dataset in the K sample sub-datasets as a train dataset, wherein K is an integer greater than 1;
training the classifier by using the train dataset, and classifying the test dataset by using a trained classifier, to obtain a second label of each sample in the test dataset;
obtaining a first indicator and a first hyper-parameter at least based on the first label and the second label, wherein the first indicator is a ratio of a quantity of samples each having a second label that is not equal to the first label in the test dataset to a total quantity of samples in the test dataset;
obtaining a loss function of the classifier at least based on the first hyper-parameter, wherein the classifier is updated using the loss function; and
completing training of the classifier when the first indicator meets a condition.

2. The training method according to claim 1, wherein the first hyper-parameter is determined based on the first indicator and a second indicator, wherein the second indicator is an average value of loss values of all samples each having a second label that is not equal to the first label in the test dataset.

3. The training method according to claim 2, wherein the first hyper-parameter is determined by using the following formula:
$$γ = a ( \frac{C *}{q *} - log b ) ,$$
wherein
γ represents the first hyper-parameter, C* represents the second indicator, q* represents the first indicator, a is greater than 0, and b is greater than 0.

4. The training method according to claim 1, wherein the obtaining of the loss function of the classifier at least based on the first hyper-parameter comprises:
obtaining the loss function of the classifier at least based on the first hyper-parameter and a cross entropy.

5. The training method according to claim 4, wherein the loss function is obtained by using the following formula:
y=γf(x)^{T}(1−eᵢ)+(−eᵢ^{T})log(f(x)), wherein
y represents the loss function, γ represents the first hyper-parameter, eᵢ represents a first vector corresponding to the first label of a first sample, f(x) represents a second vector corresponding to the second label of the first sample, the first vector and the second vector have a same dimension, and the dimension of the first vector and the second vector is a quantity of categories of the samples in the test dataset.

6. The training method according to claim 1, wherein the dividing of the sample dataset into K sample sub-datasets comprises:
equally dividing the sample dataset into the K sample sub-datasets.

7. The training method according to claim 1, wherein the classifier comprises a convolutional neural network (CNN) and a residual network ResNet.

8. A data processing method, comprising:
obtaining a dataset, wherein the dataset comprises a plurality of samples, and each of the plurality of samples comprises a first label;
dividing the dataset into K sub-datasets, wherein K is an integer greater than 1;
performing at least one classification on the dataset, to obtain first clean data of the dataset, wherein any classification in the at least one classification comprises:
determining a group of data from the K sub-datasets as a test dataset, and using sub-datasets other than the test dataset in the K sub-datasets as a train dataset;
training a classifier by using the train dataset, and classifying the test dataset by using a trained classifier, to obtain a second label of each sample in the test dataset; and
performing comparison based on the second label and the first label of each sample, to determine samples each having a second label that is equal to the first label in the test dataset, wherein the first clean data comprises the determined samples.

9. The data processing method according to claim 8, wherein after the performing of the at least one classification on the dataset, to obtain the first clean data of the dataset, the method further comprises:
dividing the dataset into M sub-datasets, wherein M is an integer greater than 1, and the M sub-datasets are different from the K sub-datasets;
performing at least one classification on the dataset, to obtain second clean data of the dataset, wherein any classification in the at least one classification comprises:
determining a group of data from the M sub-datasets as a test dataset, and using sub-datasets other than the test dataset in the M sub-datasets as a train dataset;
training the classifier by using the train dataset, and classifying the test dataset by using the trained classifier, to obtain a second label of each sample in the test dataset;
performing comparison based on the second label and the first label of each sample, to determine samples each having a second label that is equal to the first label in the test dataset, wherein the second clean data comprises the determined samples; and
determining third clean data based on the first clean data and the second clean data, wherein the third clean data is an intersection set between the first clean data and the second clean data.

10. An apparatus for training a classifier, comprising:
a memory storing executable instructions;
at least one processor configured to execute the executable instructions to cause the apparatus to perform operations comprising:
obtaining a sample dataset, wherein the sample dataset comprises a plurality of samples, and each of the plurality of samples comprises a first label;
dividing the sample dataset into K sample sub-datasets, determining a group of data from the K sample sub-datasets as a test dataset, and using sample sub-datasets other than the test dataset in the K sample sub-datasets as a train dataset, wherein K is an integer greater than 1;
training the classifier by using the train dataset, and classifying the test dataset by using a trained classifier, to obtain a second label of each sample in the test dataset;
obtaining a first indicator and a first hyper-parameter at least based on the first label and the second label, wherein the first indicator is a ratio of a quantity of samples each having a second label that is not equal to the first label in the test dataset to a total quantity of samples in the test dataset;
obtaining a loss function of the classifier at least based on the first hyper-parameter, wherein the classifier is updated using the loss function; and
completing training of the classifier when the first indicator meets a condition.

11. The apparatus according to claim 10, wherein the first hyper-parameter is determined based on the first indicator and a second indicator, wherein the second indicator is an average value of loss values of all samples each having a second label that is not equal to the first label in the test dataset.

12. The apparatus according to claim 10, wherein the at least one processor is further configured to execute the executable instructions to cause the apparatus to perform operations comprising:
obtaining the loss function of the classifier at least based on the first hyper-parameter and a cross entropy.

13. The apparatus according to claim 10, wherein the at least one processor is further configured to execute the executable instructions to cause the apparatus to perform operations comprising:
equally dividing the sample dataset into the K sample sub-datasets.

14. A data processing apparatus, comprising:
a memory storing executable instructions;
at least one processor configured to execute the executable instructions to cause the data processing apparatus to perform operations comprising:
obtaining a dataset, wherein the dataset comprises a plurality of samples, and each of the plurality of samples comprises a first label;
dividing the dataset into K sub-datasets, wherein K is an integer greater than 1;
performing at least one classification on the dataset, to obtain first clean data of the dataset, wherein any classification in the at least one classification comprises:
determining a group of data from the K sub-datasets as a test dataset, and using sub-datasets other than the test dataset in the K sub-datasets as a train dataset;
training a classifier by using the train dataset, and classifying the test dataset by using a trained classifier, to obtain a second label of each sample in the test dataset; and
performing comparison based on the second label and the first label of each sample, to determine samples each having a second label that is equal to the first label in the test dataset, wherein the first clean data comprises the determined samples.

15. The data processing apparatus according to claim 14, wherein the at least one processor is further configured to execute the executable instructions to cause the data processing apparatus to perform operations comprising:
dividing the dataset into M sub-datasets, wherein M is an integer greater than 1, and the M sub-datasets are different from the K sub-datasets;
performing at least one classification on the dataset, to obtain second clean data of the dataset, wherein any classification in the at least one classification comprises:
determining a group of data from the M sub-datasets as a test dataset, and using sub-datasets other than the test dataset in the M sub-datasets as a train dataset;
training the classifier by using the train dataset, and classifying the test dataset by using the trained classifier, to obtain a second label of each sample in the test dataset;
performing comparison based on the second label and the first label of each sample, to determine samples each having a second label that is equal to the first label in the test dataset, wherein the second clean data comprises the determined samples; and
determining third clean data based on the first clean data and the second clean data, wherein the third clean data is an intersection set between the first clean data and the second clean data.
